(19) United States
(12) Patent Application Publication
(10) Pub. No.: US 2012/0209783 A1
(43) Pub. Date: Aug. 16, 2012

(54) SYSTEMS AND METHODS USED IN THE OPERATION OF A RECYCLING ENTERPRISE

(75) Inventors: Jeffrey Carl Smith, JR., Kingwood, TX (US); Anthony Joaquin Zolezzi, Los Angeles, CA (US)

(73) Assignee: RECYCLEREWARDS, INC., NEW YORK, NY (US)

(21) Appl. No.: 13/209,341

(22) Filed: Aug. 12, 2011

Related U.S. Application Data
(63) Continuation-in-part of application No. 13/009,742, filed on Jan. 19, 2011.
Application No. 13/009,742 is a continuation-in-part of application No. 12/688,727, filed on Jan. 15, 2010.
Application No. 12/688,727 is a continuation-in-part of application No. 12/492,291, filed on Jun. 26, 2009.
(60) Provisional application No. 61/082,095, filed on Jul. 18, 2008.

(51) Int. Cl. G06Q 50/00

(52) U.S. Cl. 705/308

(57) ABSTRACT

A system and a computer program product embodied on a computer readable medium for sharing recycling related photographs with third parties on a social network site to encourage recycling. The computer program product includes receiving a recycling related photograph from a recycling user having a first user account on a recycling related web server in communication with a database having a reward point total and recycling data associated with the recycling user, receiving information related to the recycling related photograph, transmitting the recycling related photograph and at least a portion of the information to the recycling related web server via a network, for creating a user selectable link to the recycling related photograph on the first user account via the network, authorizing the recycling user access to a second user account on a social networking site via the network, transmitting the user selectable link to the second user account on the social networking site via the network, and adding a predefined reward amount to the reward point total in exchange for the recycling user sharing the recycling related photographs with third parties on the social network site.

### CROSS REFERENCE TO RELATED APPLICATIONS

The present application is a continuation-in-part of and claims priority to co-pending U.S. patent application Ser. No. 13/009,742, entitled “Systems and Methods Used in the Operation of a Recycling Enterprise,” filed in the U.S. Patent and Trademark Office on Jan. 19, 2011 and having a common inventor as the present document, which is a continuation-in-part of and claims priority to co-pending U.S. patent application Ser. No. 12/688,727, entitled “Systems and Methods Used in the Operation of a Recycling Enterprise,” filed in the U.S. Patent and Trademark Office on Jan. 15, 2010 and having a common inventor as the present document, which is a continuation-in-part of and claims priority to co-pending U.S. patent application Ser. No. 12/492,291, entitled “System and Computer Program for Managing and Tracking Recyclable Products,” filed in the U.S. Patent and Trademark Office on Jun. 26, 2009 and having a common inventor as the present document, which claims priority to U.S. provisional application Ser. No. 61/082,095, entitled “Bluedot—Method for the Design, Fabrication, Tracking and Recycling of Consumer Packaging and Products,” filed in the U.S. Patent and Trademark Office on Jul. 18, 2008. Each of the above provisional and non-provisional patent applications is hereby incorporated by reference.

### BACKGROUND OF THE INVENTION

1. Field of the Invention

The present invention is generally related to operations associated with a recycling enterprise, and more particularly to systems and methods used in the operation of a recycling enterprise.

2. Discussion of the Background

Many products are recyclable, including electronic and medical products, plastic bottles, glass, paper, metal containers and other recyclable packaging, containers and products. Such products are known as recyclable products. Similar to other products, recyclable products are manufactured, distributed and sold to consumers, typically at retail locations. After consumption, the consumer may return the recyclable product to a recycling center or station, segregate the recycling product in a recycle bin during trash pickup, or otherwise dispose of the recyclable product in a way that the recyclable product may be recycled. The recyclable product is then recycled and reprocessed.

There are numerous deficiencies associated with recycling in general, and, in particular, with operations associated with a recycling enterprise, including without limitation an efficient way to capture, audit and authenticate recyclable products, maintain and manage attributes and other information relating to recyclable products, track the location of recyclable products during their lifecycle, and reduce the manual labor associated with recycling.

There also exist numerous deficiencies associated with maintaining a rewards program in the field of recycling and with encouraging users to recycle. Many recyclable products are never recycled and end up in landfills and/or are incinerated which unnecessarily increases waste and pollution. Unfortunately, an efficient way of encouraging consumers to recycle along with managing and tracking such recyclable products does not exist in the prior art.

Until the above-identified deficiencies associated with recycling are resolved, waste and pollution will continue. Thus, there currently exist deficiencies associated with recycling in general, and, in particular, with operating a recycling enterprise.

### SUMMARY OF THE INVENTION

Accordingly, one aspect of the present invention is a computer program product embodied on a computer readable medium for sharing recycling related photographs with third parties on a social network site to encourage recycling. The computer program product includes (i) a first computer code for receiving a recycling related photograph from a recycling user having a first user account on a recycling related web server in communication with a database having a reward point total and recycling data associated with the recycling user, (ii) a second computer code for receiving information related to the recycling related photograph, (iii) a third computer code for transmitting the recycling related photograph and at least a portion of the information to the recycling related web server via a network, (iv) a fourth computer code for creating a user selectable link to the recycling related photograph on the first user account via the network, (v) a fifth computer code for authorizing the recycling user access to a second user account on a social networking site via the network, (vi) a sixth computer code for transmitting the user selectable link to the second user account on the social networking site via the network, and (vii) a seventh computer code for adding a predefined reward amount to the reward point total in exchange for the recycling user sharing the recycling related photographs with third parties on the social network site.

The information includes a description of the recycling related photograph. The user selectable link includes at least a portion of information. The user selectable link is accessible to third parties on the social networking site and wherein the recycling related photograph on the recycling related web server is displayed to the third parties upon selection of the user selectable link.

Another aspect of the present invention is a system for sharing recycling related photographs with third parties on a social network site to encourage recycling. The system includes: (i) a central server, (ii) a plurality of remote computers of recycling users having a first user account on the central server, (iii) a network interface in communication with the central server, the plurality of remote computers over a network, and one or more social networking sites, and (iv) a database in communication with the central server. The database includes a reward point total and recycling data respectively associated with the recycling users. At least one of the plurality of remote computers is configured to: (i) receive a recycling related photograph from at least one of the recycling users, (ii) receive information related to the recycling related photograph, wherein the information includes a description of the recycling related photograph, (iii) transmit the recycling related photograph and at least a portion of the information to the central server, (iv) create a user selectable link to the recycling related photograph on the first user account via the network, (v) authorize the recycling user access to a second user account on the social networking site via the network, and (vi) transmit the user selectable link to the second user account on the social networking site via the network. The user selectable link includes at least a portion of information. The user selectable link is accessible to third parties on the social networking site. The recycling related photograph on the recycling related central server is displayed to the third parties upon selection of the user selectable link.

The central server is configured to: (i) receive the recycling related photograph and at least a portion of the information from the at least one of the plurality of remote computers via the network interface, (ii) store the recycling related photograph and the at least a portion of the information in the database, (iii) transmit the reward point total and recycling data associated with the respective recycling user to the at least one of the plurality of remote computers via the network interface, and (iv) add a predefined reward amount to the reward point total in exchange for the recycling user sharing the recycling related photographs with third parties on the social network site. The recycling related photograph is accessible on the central server to third parties via the user selectable link

### BRIEF DESCRIPTION OF THE DRAWINGS

A more complete appreciation of the present invention and many of the attendant advantages thereof will be readily obtained as the same becomes better understood by reference to the following detailed description when considered in conjunction with the accompanying drawings, wherein:

FIG. 1 is a block diagram illustrating an exemplary recycling arrangement associated with a recycling enterprise in accordance with an embodiment of the present invention;

FIGS. 2A-2I are block diagrams illustrating an exemplary database schema associated with a recycling enterprise in accordance with an embodiment of the present invention;

FIG. 3 is a block diagram illustrating an exemplary configuration for providing and accessing information associated with a recycling enterprise over a network in accordance with an embodiment of the present invention;

FIG. 4A is a flow chart illustrating a method for managing and tracking recyclable products in accordance with an embodiment of the present invention;

FIG. 4B is a flow chart illustrating a method for tracking recycling users in accordance with an embodiment of the present invention;

FIGS. 4C and 4D are flow charts illustrating methods for maintaining a rewards program in accordance with an embodiment of the present invention;

FIG. 4E is a flow chart illustrating a method for interacting with a recycling user using a recycling center or station in accordance with an embodiment of the present invention;

FIG. 4F is a flow chart illustrating a method for receiving a recyclable at a materials recovery facility or a recycling center or station product in accordance with an embodiment of the present invention;

FIG. 5A is a block diagram illustrating the placement of an exemplary unique identifier on a recyclable product in accordance with an embodiment of the present invention;

FIG. 5B is a block diagram illustrating an automated recyclable product collection location in accordance with an embodiment of the present invention;

FIG. 6 is a block diagram illustrating exemplary database tables used for managing and tracking recyclable products in accordance with an embodiment of the present invention;

FIG. 7A is a block diagram illustrating an exemplary unique identifier used for managing and tracking recyclable products in accordance with an embodiment of the present invention;

FIG. 7B is a block diagram illustrating an exemplary coding types used for managing and tracking recyclable products in accordance with an embodiment of the present invention;

FIG. 8A is a block diagram illustrating a tracking module implemented by a mobile device that is used to identify and track recycling activities in accordance with an embodiment of the present invention;

FIG. 8B is a block diagram illustrating one possible implementation of a scanning module implemented by a mobile device that is used to scan and review recycling activities in accordance with an embodiment of the present invention;

FIGS. 8C-8G are block diagrams illustrating another possible implementation of a scanning module implemented by a mobile device that is used to scan and review recycling activities in accordance with an embodiment of the present invention;

FIG. 8H is a block diagram illustrating one possible implementation of a web-based recycling scorecard in accordance with an embodiment of the present invention;

FIGS. 9A-9D are block diagrams illustrating one possible implementation of a recycling related web-based interface in accordance with an embodiment of the present invention;

FIGS. 10A-10F are block diagrams illustrating one possible implementation of a recycling center or station interface in accordance with an embodiment of the present invention;

FIG. 11 is a block diagram illustrating an exemplary communication to a recycling user in accordance with an embodiment of the present invention;

FIG. 12 is a block diagram illustrating collected recycling information in accordance with an embodiment of the present invention;

FIG. 13 is a block diagram illustrating a system for connecting recycling users with various recycling activities in accordance with an embodiment of the present invention;

FIG. 14 is a block diagram illustrating improvements to a recycling vehicle in accordance with an embodiment of the present invention;

FIGS. 15A-15D are flow charts illustrating a method for communicating with recycling users while their recycling materials are collected by a recycling vehicle in accordance with an embodiment of the present invention;

FIG. 16A is a block diagram illustrating an exemplary arrangement for photosharing recycling related photographs in accordance with an embodiment of the present invention;

FIGS. 16B-16C are flow charts illustrating a method for photosharing recycling related photographs in accordance with an embodiment of the present invention;

FIGS. 17A-17Z are block diagrams illustrating one possible implementation of a photosharing App interface in accordance with an embodiment of the present invention; and

FIGS. 18A-18B are block diagrams illustrating one possible implementation of a photosharing web-based interface in accordance with an embodiment of the present invention.

### DETAILED DESCRIPTION THE PREFERRED EMBODIMENTS

Referring now to the drawings, wherein like reference numerals designate identical or corresponding parts throughout the several views, preferred embodiments of the present invention are described.

### I. Managing and Tracking Recyclable Products

The present invention provides a computer program and method for managing and tracking recyclable products, including without limitation a way to easy capture, audit and authenticate recyclable products, maintain and manage attributes and other information relating to the recyclable products, and track the location of recyclable products during their lifecycle. The present invention provides for the easy capture and authentication of recyclable products, and provides the ability to audit the recyclable products.

The present invention provides information associated with the recyclable products, including without limitations the ability to track recyclable products and ascertain other information about such recyclable products, such as its attributes and location. Using the present invention, a recycling user may confirm whether the recyclable product is composed of non-toxic or toxic materials, manage recycling product information, and track the recyclable product during its lifecycle in near real-time using an online web server.

In one embodiment, each recyclable product has a unique identifier and other indicia included in the printed label or product for capturing redundancies. The system uses proprietary algorithms to create unique unit level bar or symbol based security or tracking codes. Security or tracking codes are generated on demand when the recyclable product is manufactured or packaged. An open architecture which allows for flexible integration into various manufacturing environments is utilized. Security or tracking codes may be encrypted with the strongest methodology available with non-sequential, non-predictable and non-repeating codes.

According to one embodiment, recyclable products can be verified at any point in the supply chain via without limitation the Internet, SMS, a hand-held scanner, or a camera phone. Security or tracking codes can be authenticated by manufacturers, security personnel, retail associates and consumers at various stages in the recyclable product's lifecycle. Unit level authentication is available to a user using a camera phone, a hand-held scanner, SMS, or by means of the Internet.

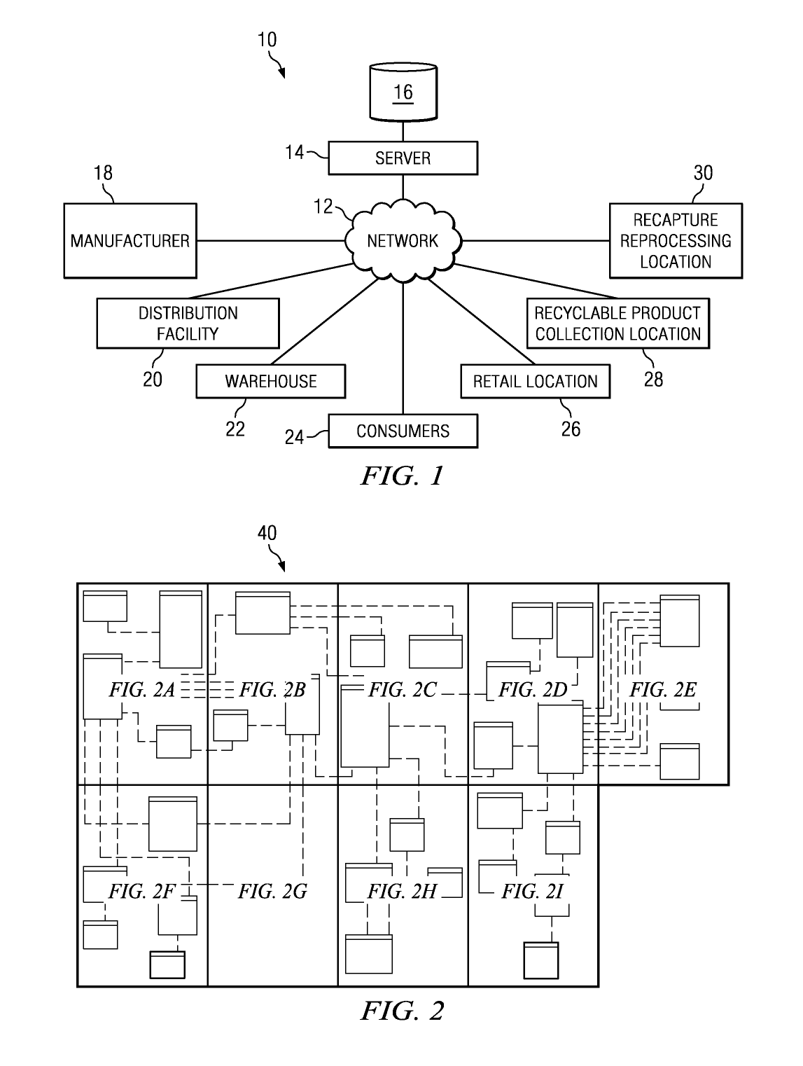

Referring to FIG. 1, a block diagram illustrating an arrangement for managing and tracking recyclable products in accordance with an embodiment of the present invention is shown. According to this arrangement, one or more users associated with a recyclable product's lifecycle communicate with server 14 to access and possibly update information associated with recyclable products. Users associated with a recyclable product's lifecycle or otherwise interested in recycling, referred to herein as recycling users, include without limitation manufacturers 18, distribution facilities 20, warehouses 22, retail locations 24, consumers 26, recyclable product collection locations 28 and recapture reprocessing locations 30. The recyclable product information is stored in one or more databases 16 in communication with server 14.

In one non-limiting embodiment, server 14 is a web server, or the like, able to communicate with one or more users associated with a recyclable product's lifecycle via network 12, such as without limitation the Internet, an Intranet or other communication network. Server 14 includes a computer with one or more processors and a computer readable storage medium, such as without limitation a computer hard-drive, removable drive or memory. A computer program having executable instructions may be stored on the computer readable storage medium.

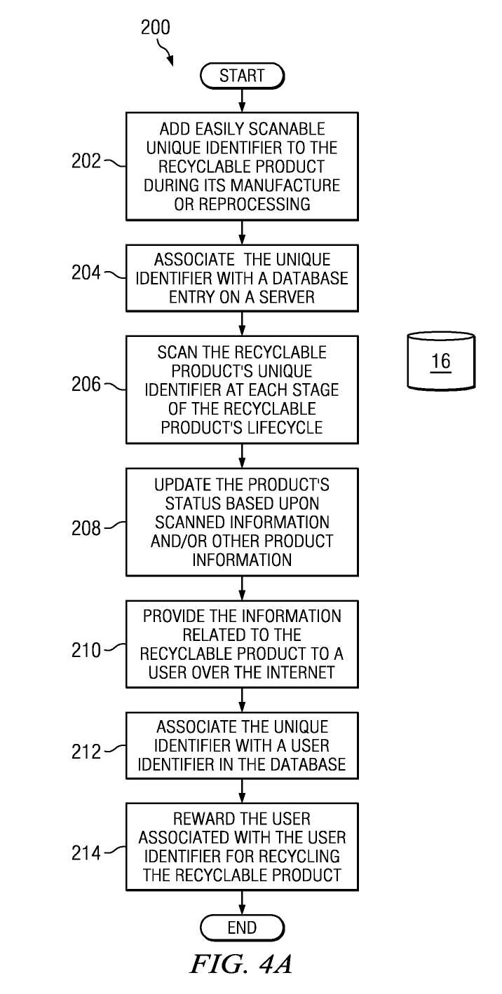

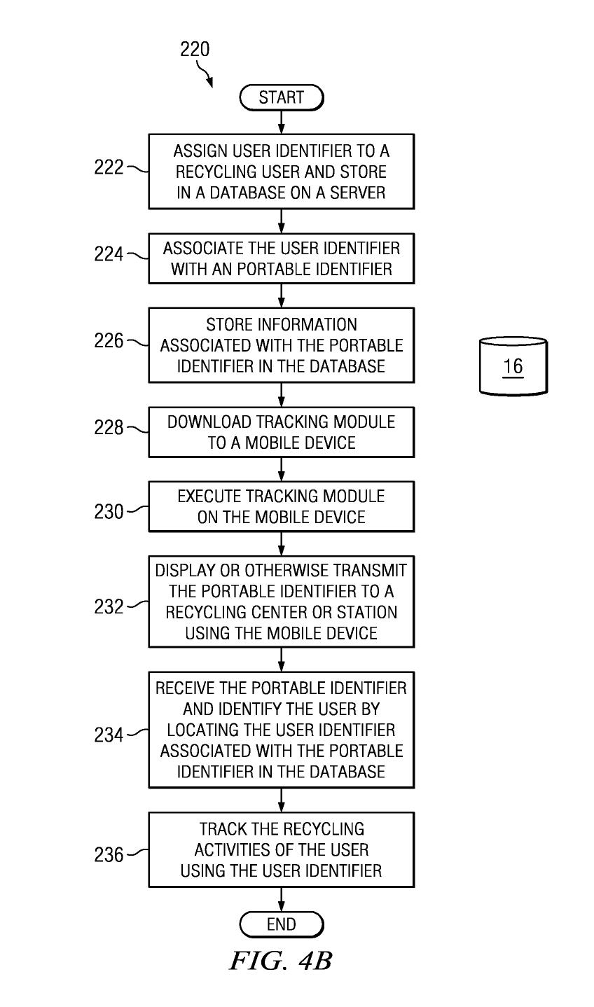

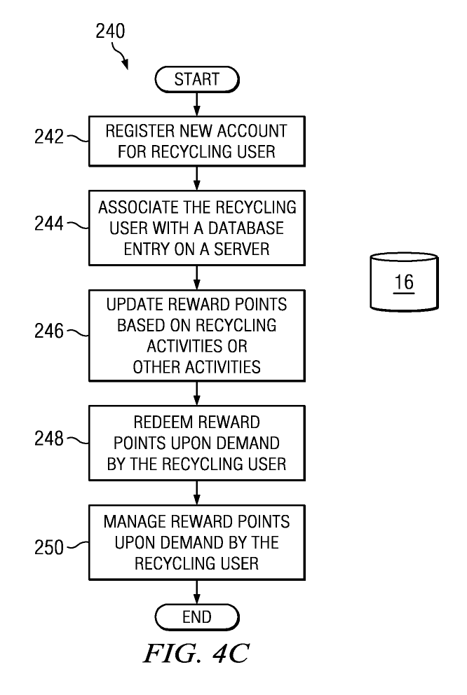

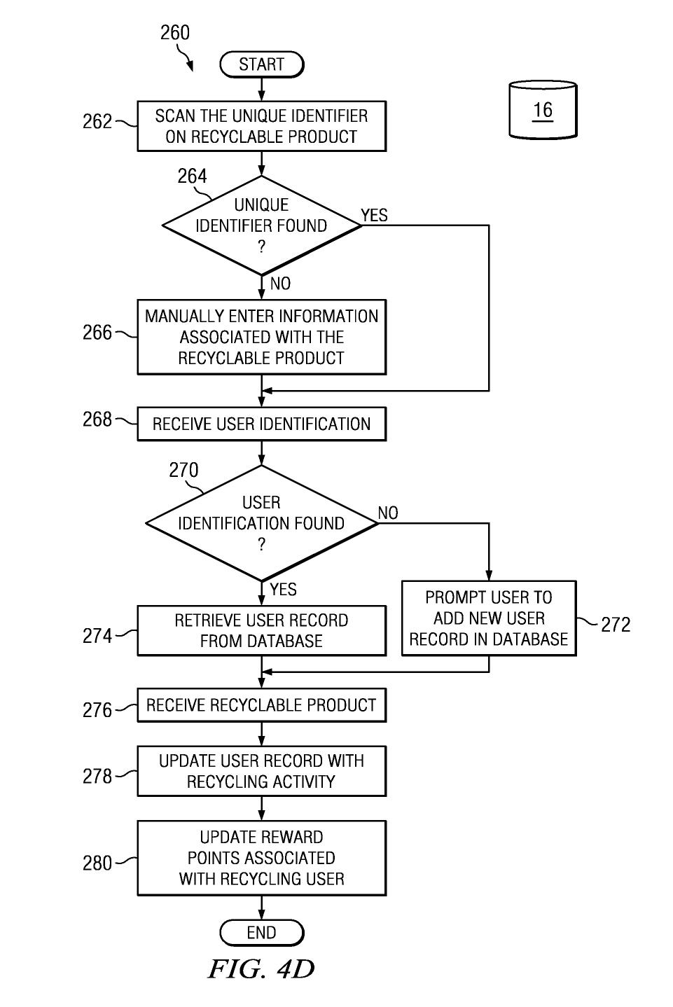

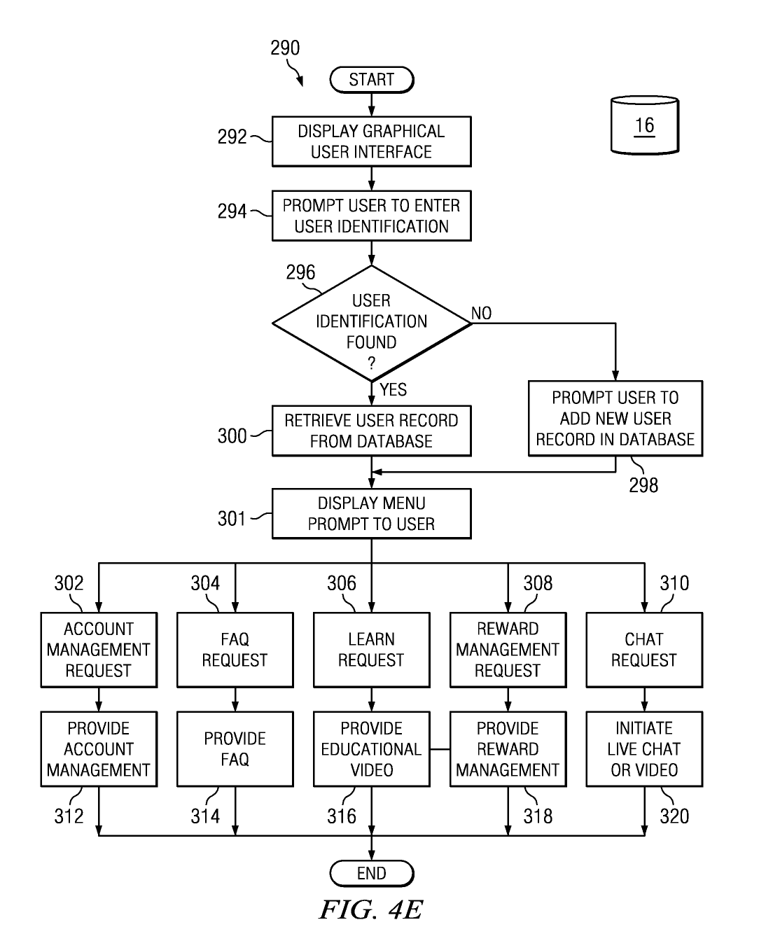

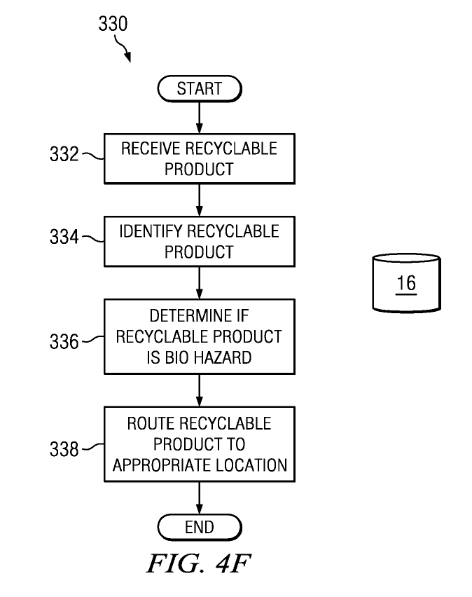

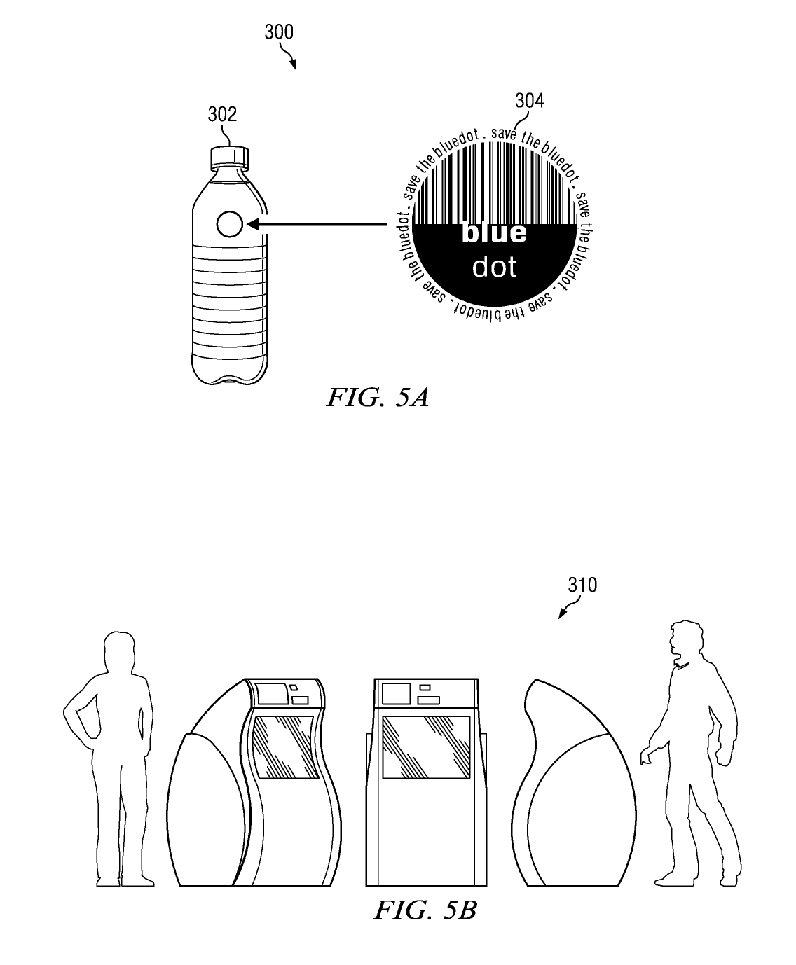

Referring to FIG. 4A, a flow chart illustrating a method for managing and tracking recyclable products in accordance with an embodiment of the present invention is shown. At block 202, a scannable unique identifier is added to a recyclable product during its manufacture or reprocessing. According to one embodiment, the unique identifier visually identifies the product as a recyclable product to a consumer, thereby encouraging the consumer to recycle to the recyclable product each time the recyclable product is viewed or used by the recycling user. In one embodiment, a bluedot symbol 304 as shown in FIG. 5A is added to a recyclable product 302. The bluedot symbol 304 not only visually identifies the product as a recyclable product, but also uniquely identifies the recyclable product such that it may be tracked during its recyclable lifecycle. However, it is understood that a visual identification of the product as a recyclable product is not required within the scope of the present invention and that any unique identifier may be used. For instance, the unique identification may be by means of a unique barcode, variable scan tracking symbol, tag, number. RFD or the like. According to at least one embodiment, the unique identifier is globally unique to all recyclable products. However, it is understood that such global uniqueness is not necessarily required under other embodiments of the present invention. For instance, it is understood that the unique identifier may be unique to a region, a classification, a product type, or the like, under alternative embodiments of the present invention.

At block 204, the unique identifier is associated with at least one entry in a database, such as database 16 in communication with server 14, as shown in FIG. 1. The recyclable product identifier may be scanned at one or more stages of the recyclable product's lifecycle, as shown at block 206. In one embodiment, the recyclable product identifier is scanned at each stage of the recyclable product's lifecycle. A recyclable product's lifecycle includes without limitation its manufacturing, storage, distribution, retail, recycling, and reprocessing stages. According to one embodiment, at one or more, or each, of these stages the unique identifier is scanned using a barcode or variable scan tracking symbol reader. According to other embodiments, the identifier is scanned using other scanning technologies, such as without limitation laser, x-ray, UV florescent or RFID scanning. The recyclable product's status is updated based upon scanned information and/or other information manually or automatically entered at block 208.

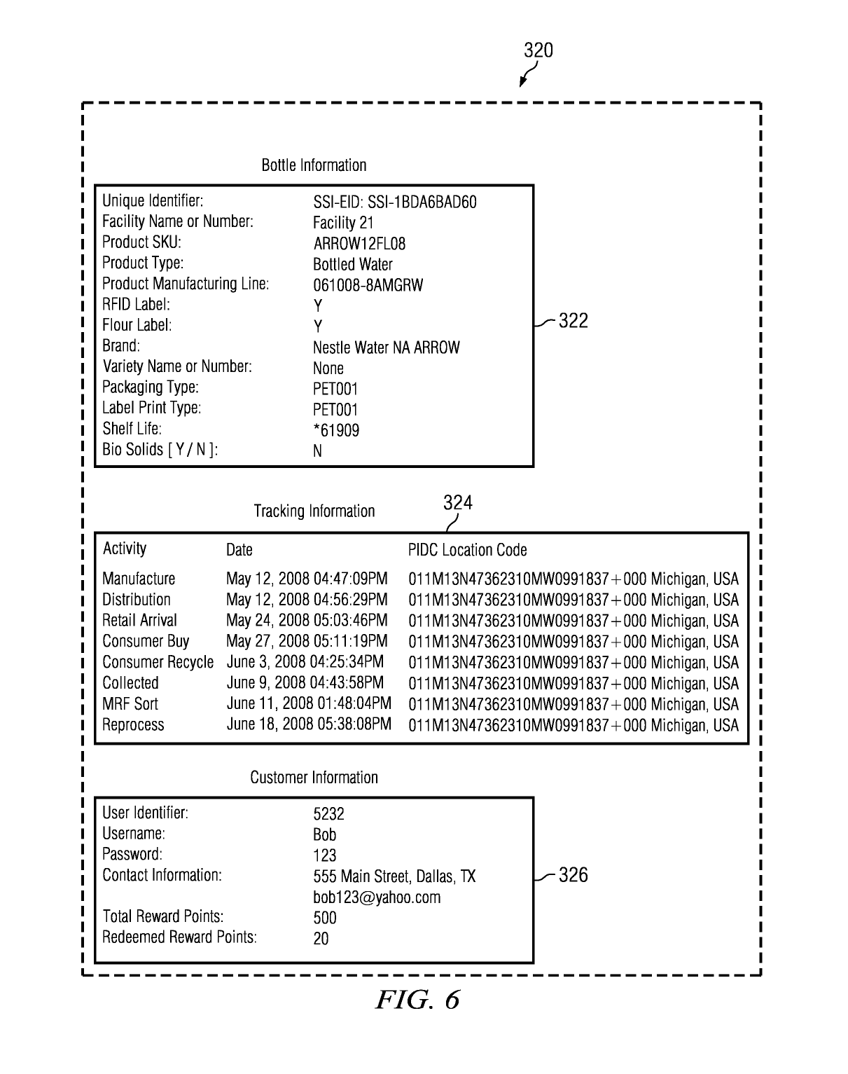

At block 210, information about the recyclable product is provided to a recycling user over a network, such as the Internet. In one embodiment, the information includes status information relating the stage of the recyclable product's lifecycle. As shown in table 424 of FIG. 6, the information may include tracking information, including without limitation the activity, date and PIDC location code. The PIDC location code is the product identification code and may be used to indicate where and when an event occurred within the recyclable product's lifecycle. As shown in table 422 of FIG. 6, the information may also include bottle information, including without limitation a unique identifier, a facility name and/or number, a product SKU, a product type, a product manufacturing line, an indication of whether the recyclable product includes an RFID label, a brand, a variety name and/or number, a packaging type, a label print type, a shelf life, and an indication of whether the product is a plastic, glass aluminum, or other type of material. The type of material indicates whether the product is a bio solid or a technical solid. For instance, fruit waste is a bin solid and plastic is a technical solid.

At block 212, the unique identifier is associated with a user identifier in a database. In one embodiment, unique identifier is associated with a user identifier in a customer information table. As shown in table 426 of FIG. 6, customer information includes without limitation a user identifier, a username, a password, contact information, a total number of reward points and a redeemed number of reward points. The unique identifier may be associated with a user without limitation when it is purchased by a consumer and scanned at a retail location, when it is returned by the consumer after consumer to a recycling center or station, when it is picked up from a recycling container during trash pickup, or when the recyclable product is otherwise recycled by the consumer.

In one embodiment, the recyclable product is scanned by a recycling user at a recycling center or station, during trash pickup, at a reprocessing location, at home or at a community location. The scanned information is used to identifying the product as a recycle product and to automatically segregate the recyclable products into separate bins or storage locations. Thereby, the amount of manual labor required during recycling and reprocessing may be reduced.

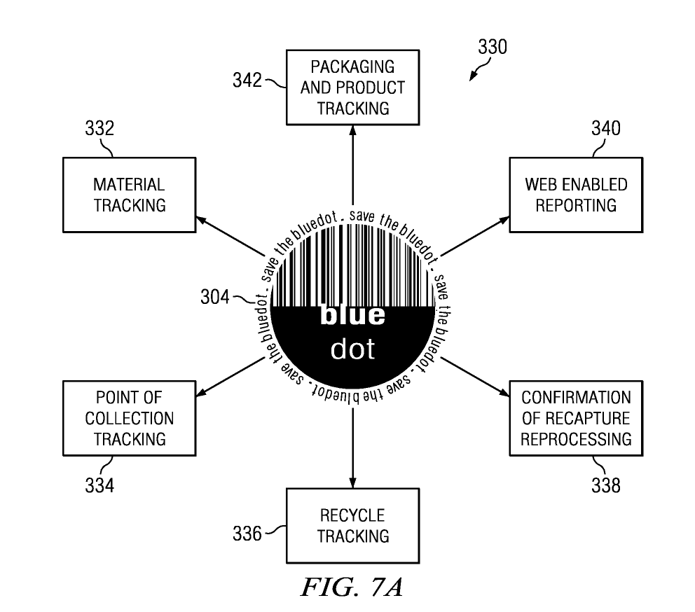

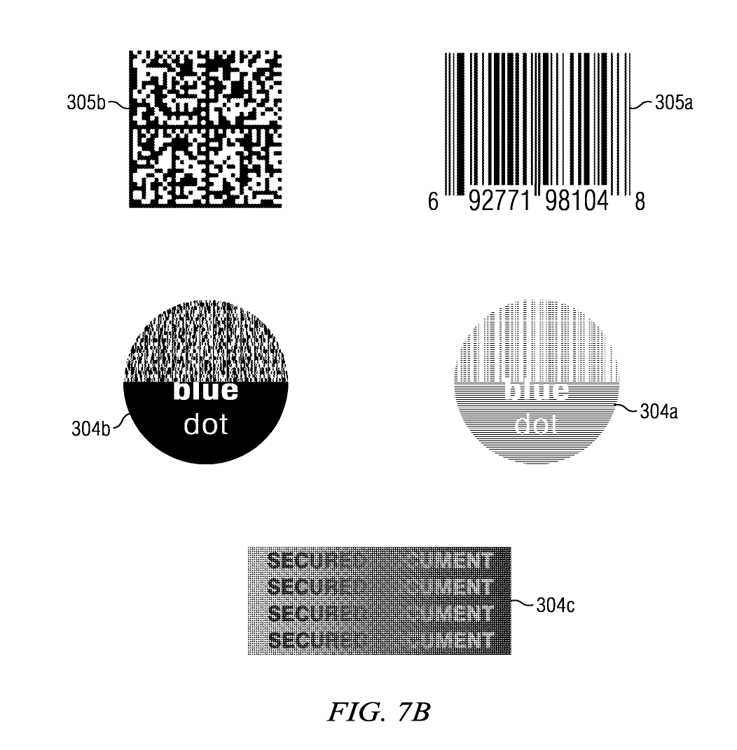

As shown in FIG. 7A, according to one embodiment the unique identifier 304 may be used for material tracking 332, point of collection tracking 334, recycling tracking 336, confirmation of recapture reprocessing 338, web enabled reporting 340, and packing and product tracking 342.

The present invention includes the capability to capture information associated with recyclable products, authenticate recyclable products, and prepare reports associated with the recyclable products. It uses encoding and decoding technologies to track recyclable products, recyclable product packaging and/or other materials after consumption. As previously described, encoding and decoding technologies may include a barcode, variable scan tracking symbol, tag, number, RFID or the like.

According to at least one embodiment, tracking is accomplished using a unique identifier affixed to packaging, products and/or materials associated with recycling. The unique identifier provides unique recognitions for the recyclable product, recyclable product packaging and/or other material that distinguishes it from the other similar items. The unique identifier may be affixed or marked on the packaging, product or material by any means known in the art. For instance, the unique identifier may be in the form of a 1-D or 2-D barcode, such as a 2-D data matrix barcode symbol, which is etched on a square grid. The marking may be either directly engraved on the packaging, product or material or affixed as labels or nameplates. However, preferably, the marking should be permanent for the lifetime of the recyclable packaging, product or material. However, it is understood that according to alternative embodiments, non-permanent marking may also be used. As is known in the art, two dimensional barcodes (also known as “2-D barcodes”) contain more information than conventional one dimensional linear barcodes (also known as “1-D barcodes”). 1-D barcodes typically get wider as more data is encoded. 2-D barcodes make use of the vertical dimension such that more data may be stored. 2-D barcodes are typically scanned using auto scanning CCD and laser scanners. These technologies may be incorporated into the unique identifier, including without limitation, unique identifiers 304a and 304b shown in FIG. 7B. Unique identifier 304a represents a 1-D barcode (305a represents a detailed portion of unique identifier 304a) and 304b represents a 2-D barcode (305b represents a detailed portion of unique identifier 304b). It is understood that any possible arrangement and configuration of barcode or variable scan tracking symbol is within the scope of the present invention. For instance, the unique identifier of the present invention is not limited to a circular barcode and may, instead, be any shape such as rectangular. Further, the unique identifier of the present invention is not limited to combination with an image, such as the bluedot earth image.

As shown in FIG. 7B, the unique identifier may utilize any encoding that provides a unique identification. For instance, without limitation, the unique identifier may use a variable code generated in a digital printing environment (304b), the unique identifier may be a UPC code generated in an offset printing environment (304a), the unique identifier may be an invisible fluorescent stripe generated in an offset printing environment (304c), the unique identifier may be a unique image or picture (not shown), and the like.

According to one embodiment, variable 2-D encoding may be used to track the product life of a packaging, product or material associated with recycling. Alternatively, 1-D UPC encoding may be used to track the product life of a packaging, product or material associated with recycling using that recyclable product's SKU (an abbreviation for “stock keeping unit”), which is a number or string of alpha or numeric characters that unique identify a product. As is known in the art, a UPC (an abbreviation for “universal product code”) is a barcode symbology that is widely used in the United States and Canada for tracking items. SKUs are typically universal numbers, such as a UPC code or supplier part number, or may be a unique identifier used by a specific store, retailer or manufacture.

According to at least one embodiment, at some point during the life cycle of the packaging, products and/or materials associated with recycling, a unique identifier is affixed or marked on the recyclable product, recyclable product packaging and/or other material by any means known in the art. Typically, this occurs during the manufacture or re-manufacture stage for the packaging, product or material. However, such marking is not limited to such stages and may also occur during other stages of the product's lifecycle, such as upon arriving at a store or retail location or a distribution center. The present invention includes a database configuration which can be integrated to other segments of a value chain, including, without limitation, from primary manufacturing to secondary re-manufacturing.

The database is accessible over via a network, such as the Internet, Intranet or propriety network. At some point during the life cycle of the packaging, products and/or materials associated with recycling, the unique identifier for such item is stored in the database along with other relevant data associated with such item. Typically, this occurs during the manufacture or re-manufacture stage for the packaging, product or material. However, such marking is not limited to such stages and may also occur during other stages of the product's lifecycle, such as upon arriving at a store or retail location or a distribution center. Alternatively, this may also occur when the packaging, product or material is scanned upon purchase by a consumer or when the item is presented for recycling at a recycling center or station, such as a tracking station, remote kiosk, reverse vending machine and the like. In either case, hardware and software components, such as a barcode scanner, network interface and associated software, are provided such that the unique identifier may be scanned by the manufacturer, retailer, consumer and/or recycling user, and the unique identifier is communicated over the network interface to the database and stored in the database. Such scanning may occur at multiple stages of the product's lifecycle. Other data associated with the packaging, product or material may also be communicated to the database, such as without limitation the type of packaging, product or material, the current stage in the lifecycle of such item via one or more graphical user interfaces.

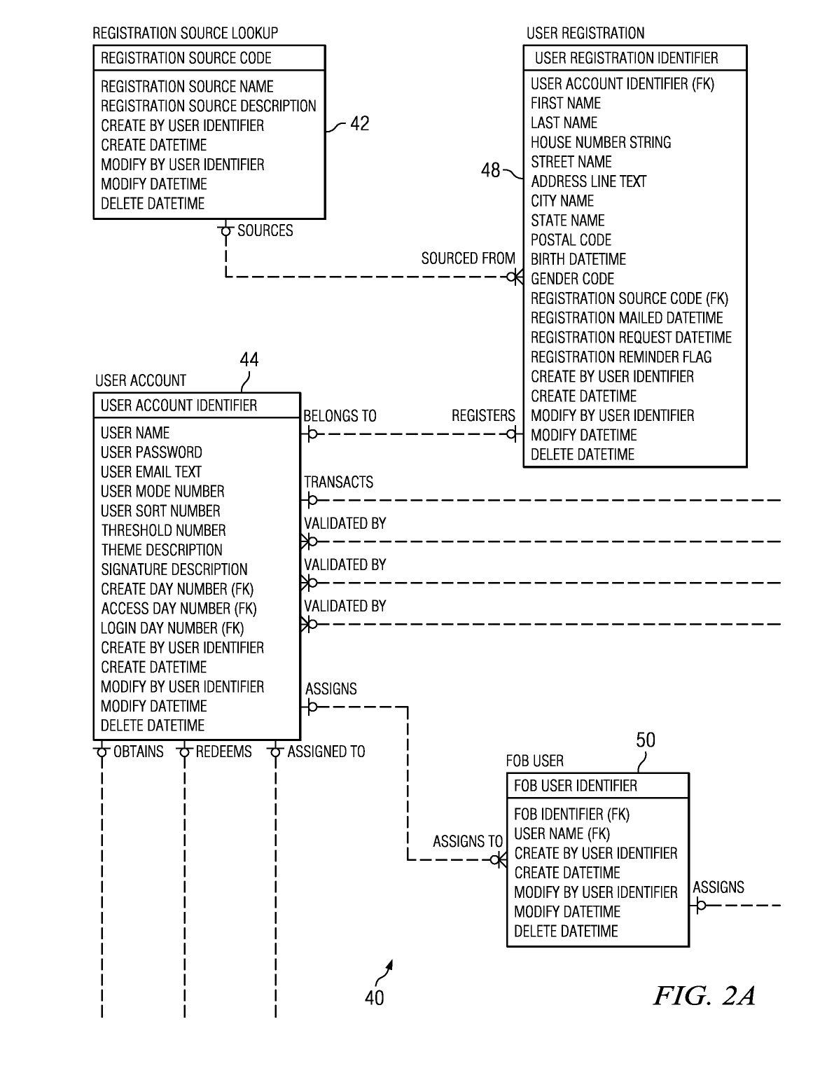

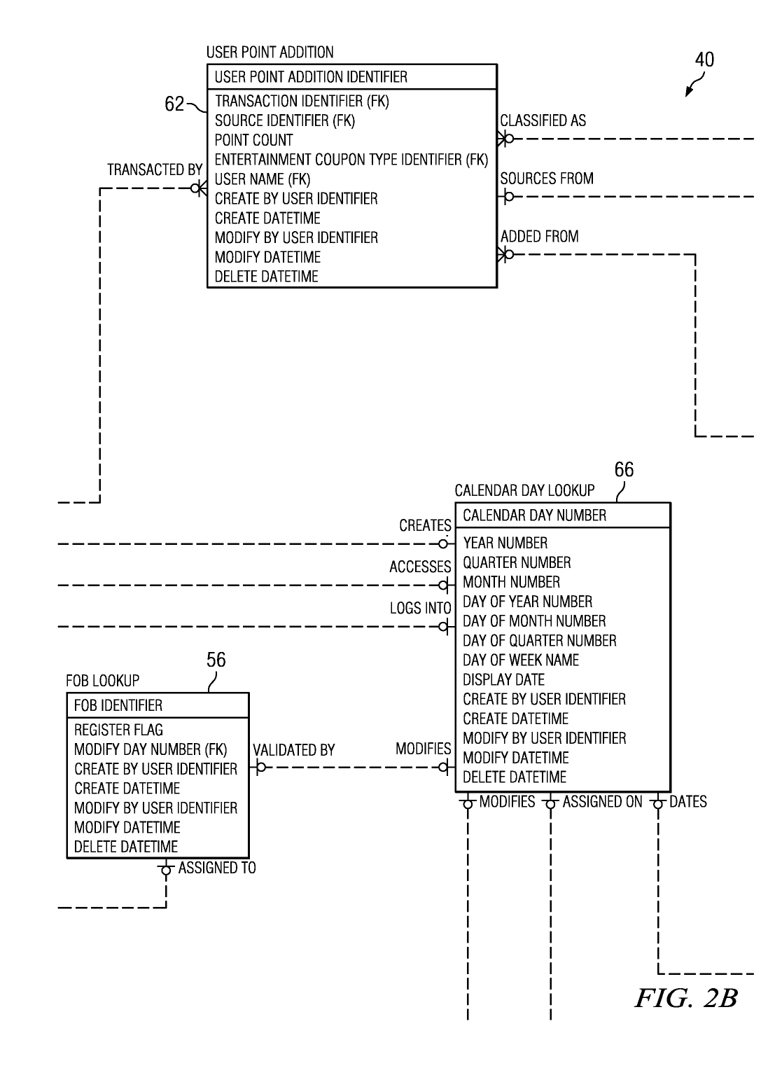

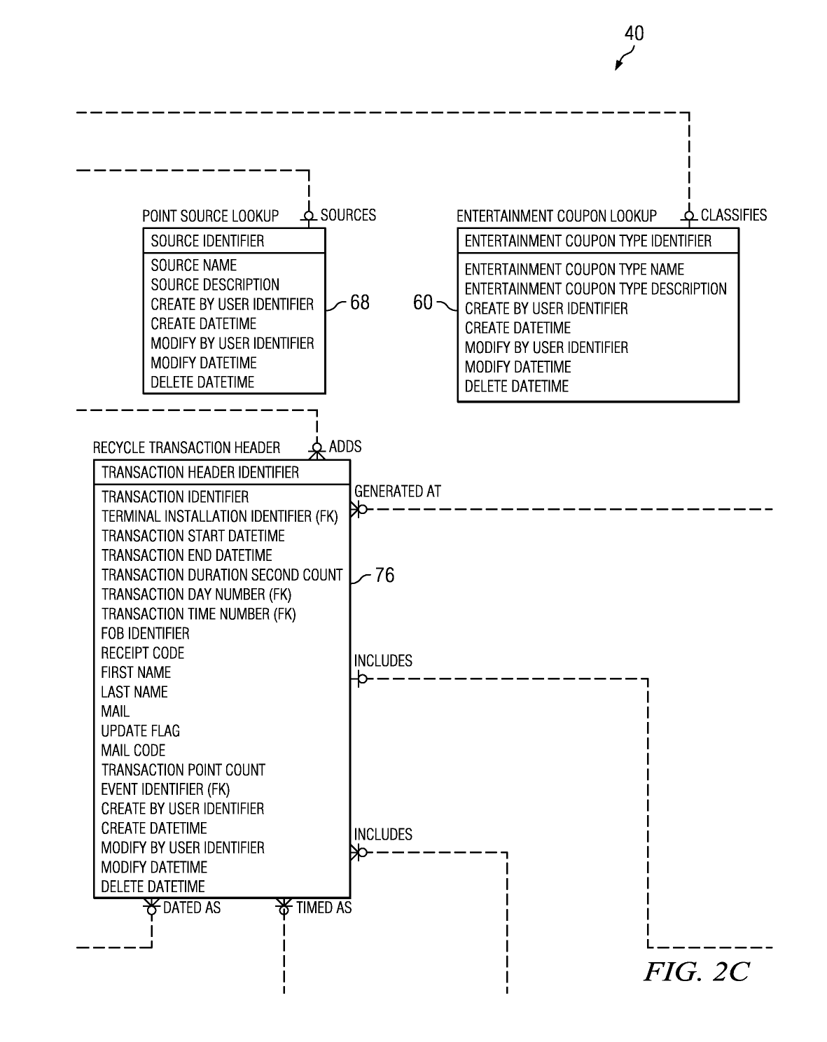

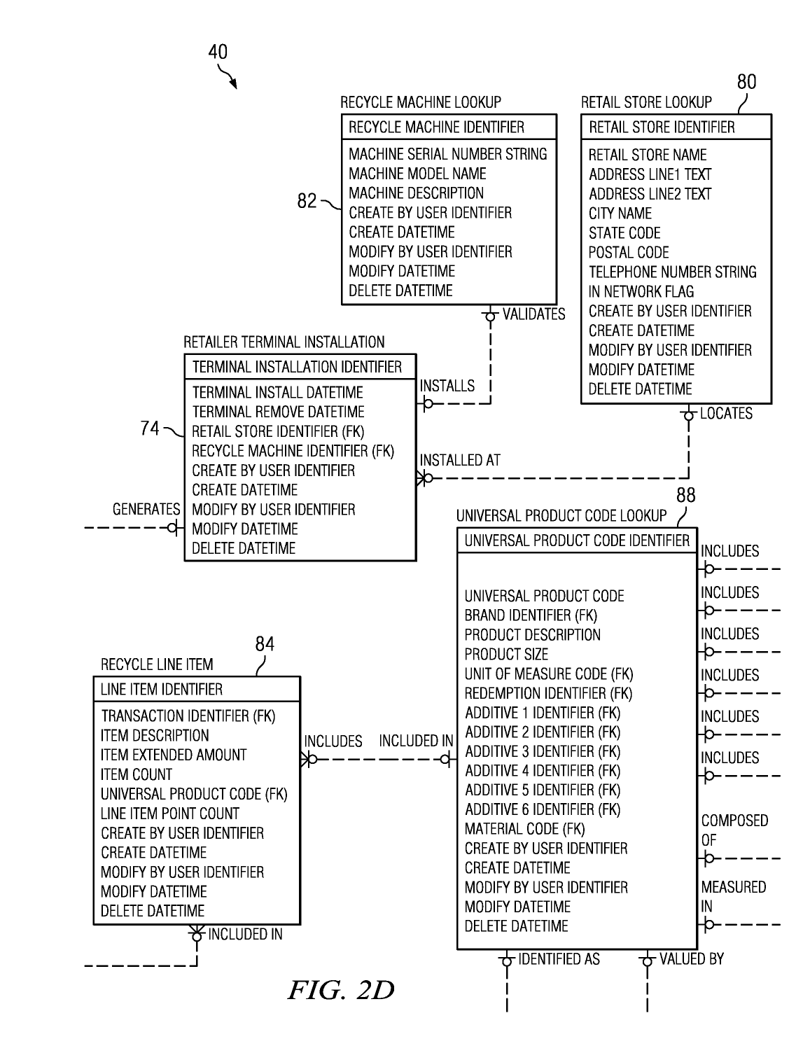

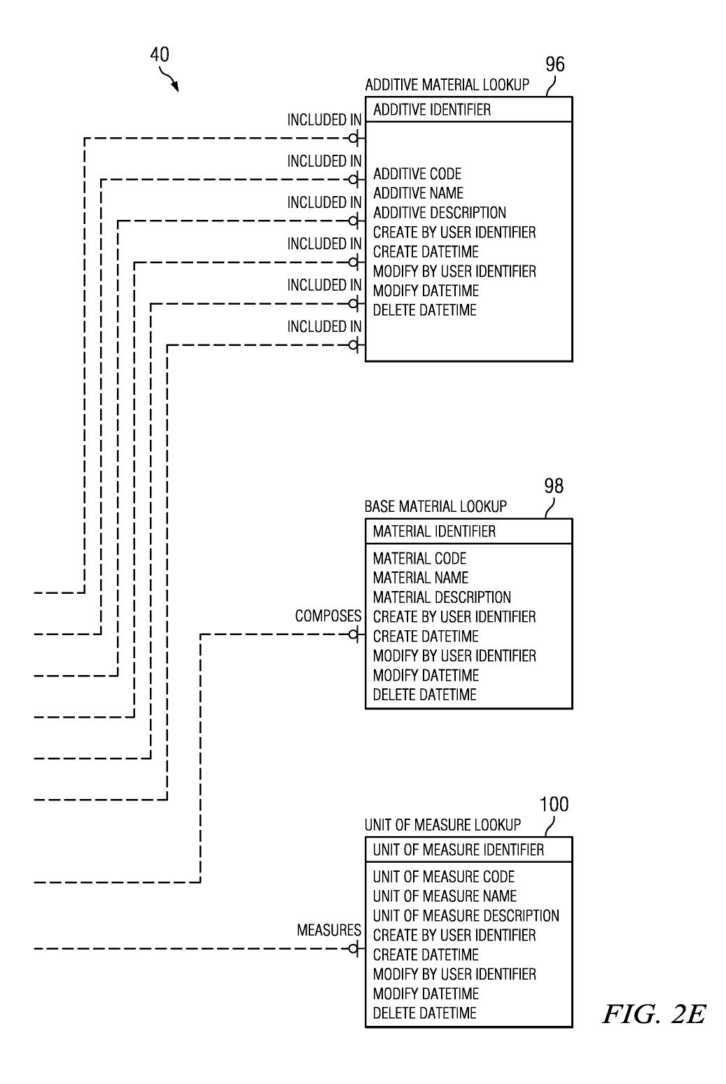

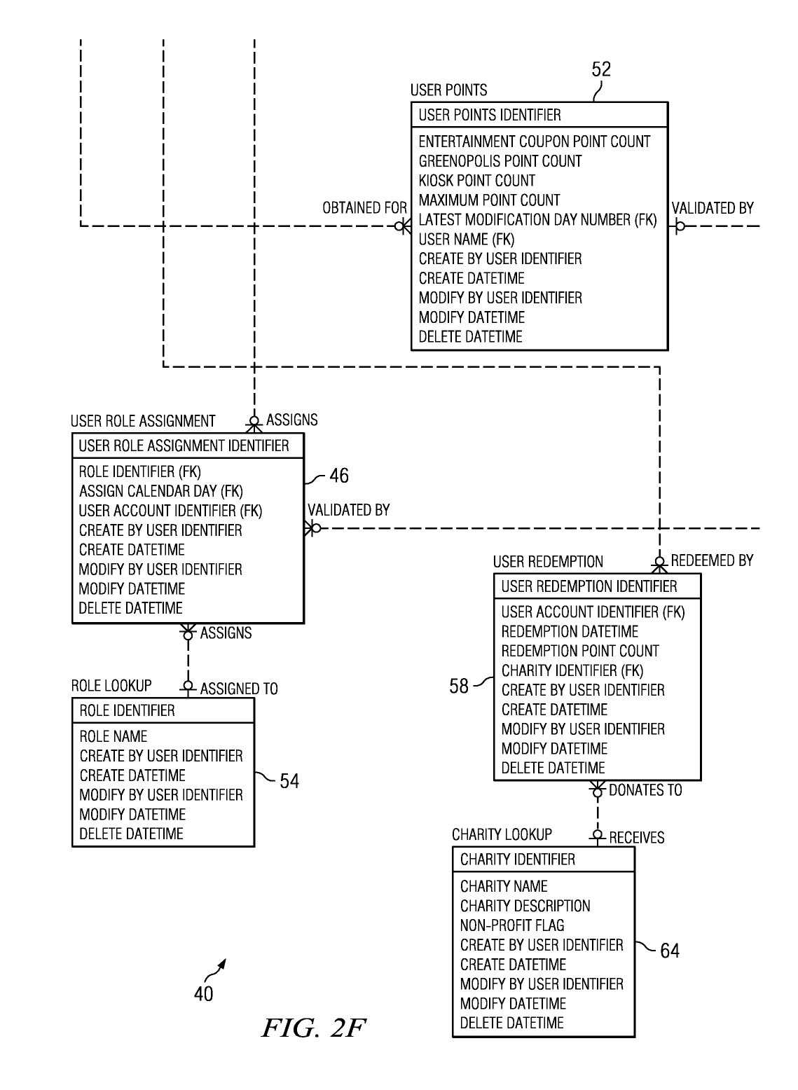

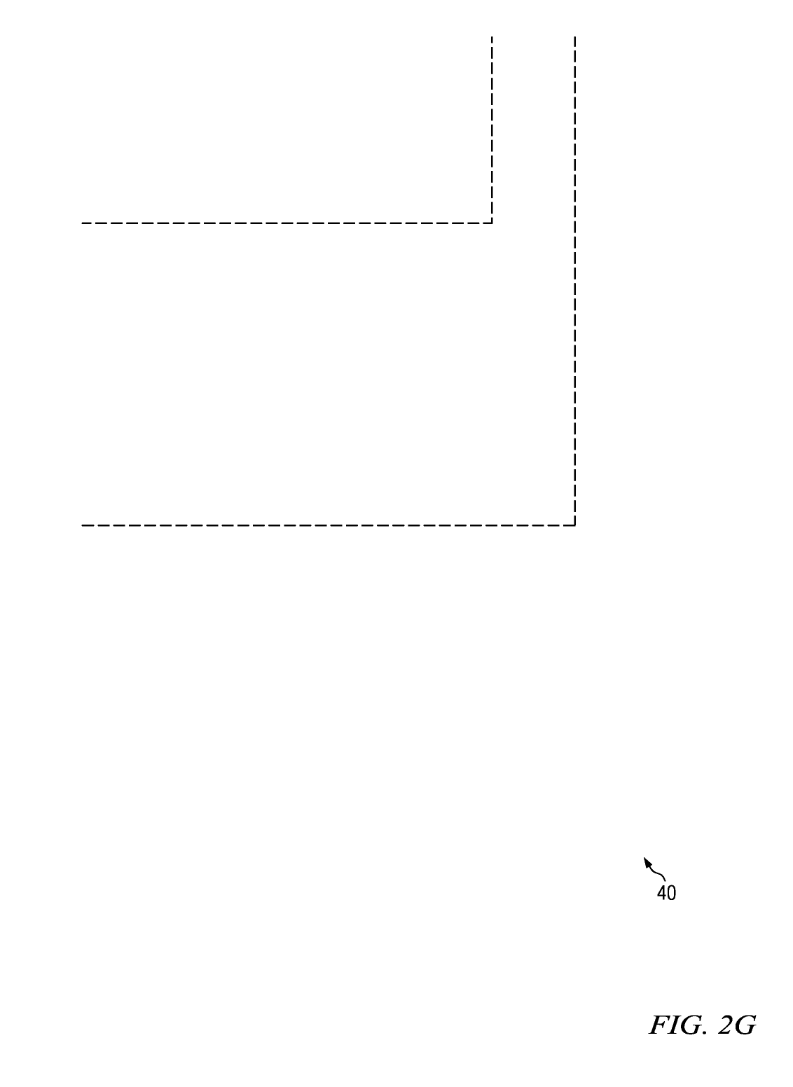

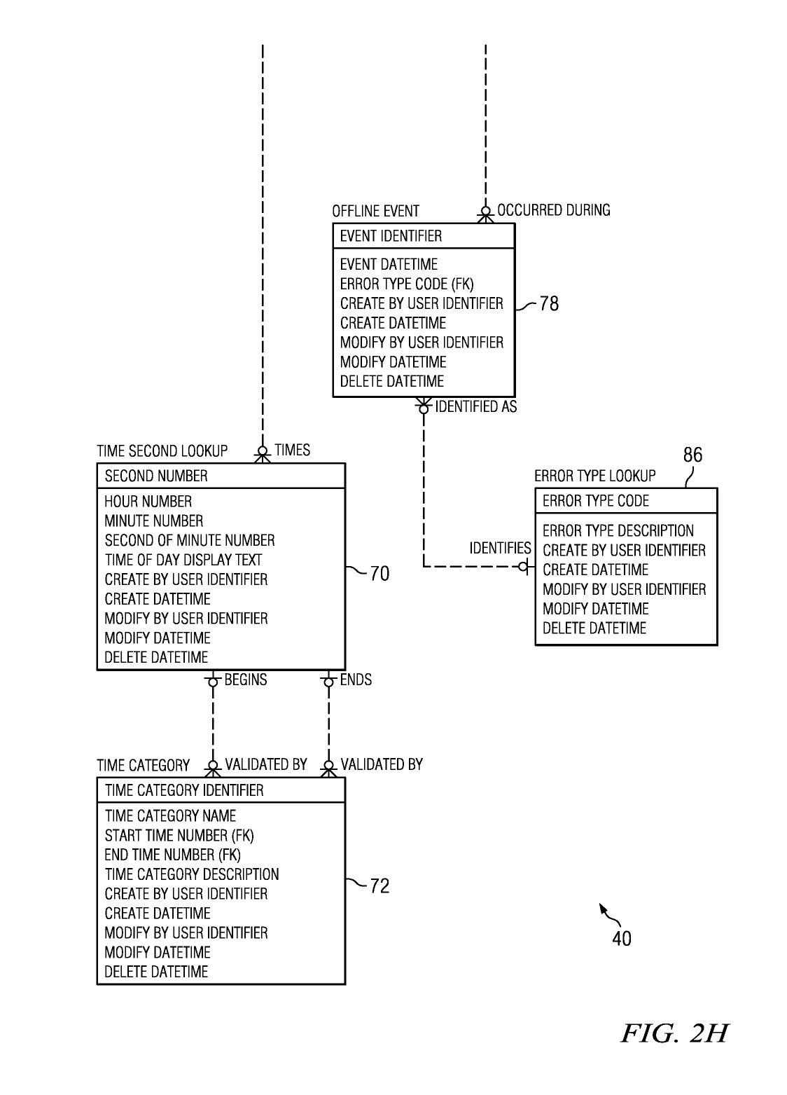

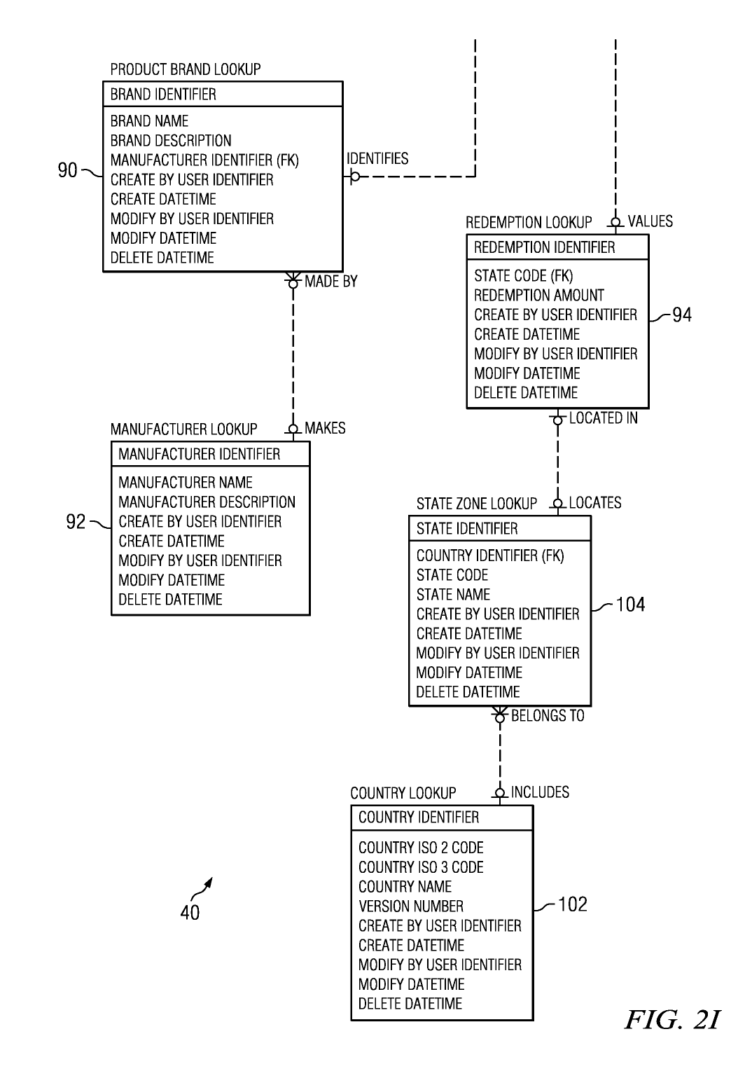

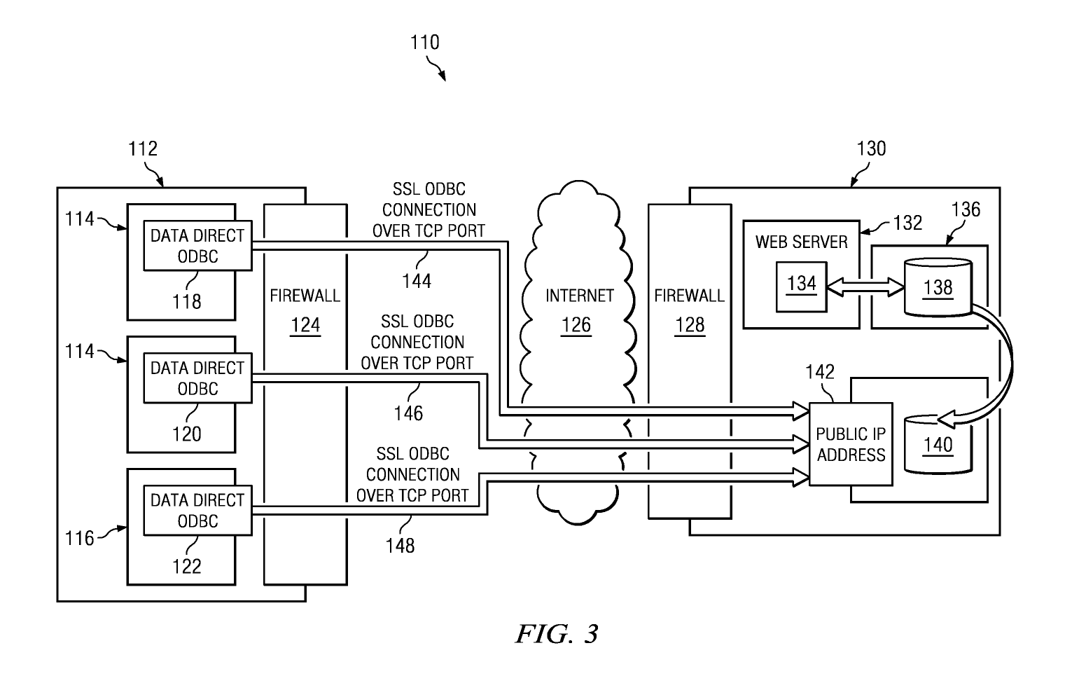

Referring to FIGS. 2A-2I, block diagrams illustrating an exemplary database schema associated with a recycling enterprise in accordance with an embodiment of the present invention are shown. Utilizing the database tables shown in FIGS. 2A-2I, the operation of a recycling enterprise may be greatly improved. According to one embodiment, the database at least includes without limitation user account table 44, user registration table 48, user points table 52, and user redemption table 58. User account table 44 includes information about the recycling user. The recycling user is typically associated with a key FOB via FOB lookup table 56. User registration table 48 includes information about a recycling user that has registered his/her information for instance using the GreenOps website. User points table 52 includes various point information associated with the recycling user. User redemption table 58 includes information regarding the redemption activities of the recycling user, such as when the redemption occurred.

The database also includes information about the recyclable product. For instance, universal product code table 88 includes UPC information relating to a recyclable product, such as without limitation, a unique identifier, the brand of recyclable product, the type of material the recyclable product, the recyclable product manufacturer, and when the recyclable product was created. Recycle line item table 84 includes information about individual recyclable products recycled at, for instance, a recycling center or station. Retail store lookup table 80 includes information about the retail store where the recyclable product was recycled.

### II. Rewards Program

The present invention also encourages consumers to recycle, improves automation and reduces manual labor associated with recycling. Thereby, the amount of material recycled and reprocessed is increased. According to at least one embodiment, the unique identifier is associated with a particular user, such as the recycling user for purpose of providing a reward for the recycling activities of such user.

Referring to FIG. 4C, a flow chart illustrating a method for maintaining a rewards program in accordance with an embodiment of the present invention is shown. At block 242, a new account is registered for a recycling user. According to one embodiment, a recycling user may register a new account by accessing a web server using a web browser over a network and entering user information. Alternatively, the new account is registered by a server administrator. The recycling user is associated with a database entry on a server at block 244. According to one embodiment, a unique user identifier identifies one or more database records that contain information associated with the recycling user, information about the recycling user's activities, and reward points associated with the recycling user. At block 246, reward points are updated based on the recycling user's recycling activities or other activities. For instance, reward points are earned by the recycling user for depositing recycling products in a recycling center or station or for participating in a recycling home pickup program. Reward points may also be earned by the recycling user for participating in an environmentally focused website, listserv or blog, and the like. The reward points may also be earned by the recycling user for other activities that encourage recycling generally or are environmentally focused.

The reward points are redeemed upon demand by the recycling user at block 248. According to one embodiment, a recycling user logs in to a web server using a web browser using a username and password. At block 250, the reward points are monitored, printed, or transferred upon demand by the recycling user. The recycling user may also monitor the recycling activities associated with the recycling user. According to one embodiment, a recycling user may manage reward points, including without limitation monitoring, (printing or transferring reward points, by accessing a web server using a web browser over a network. According to an alternate embodiment, the recycling user may manage reward points using a graphical user interface located on a recycling center or station.

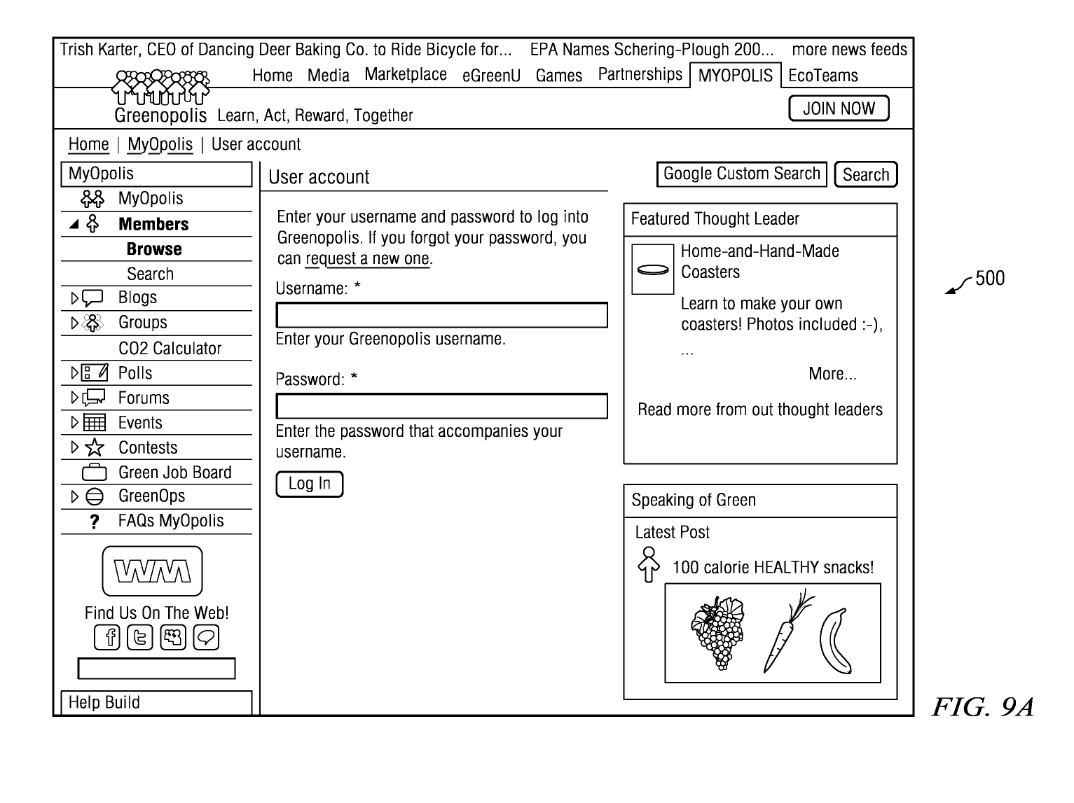

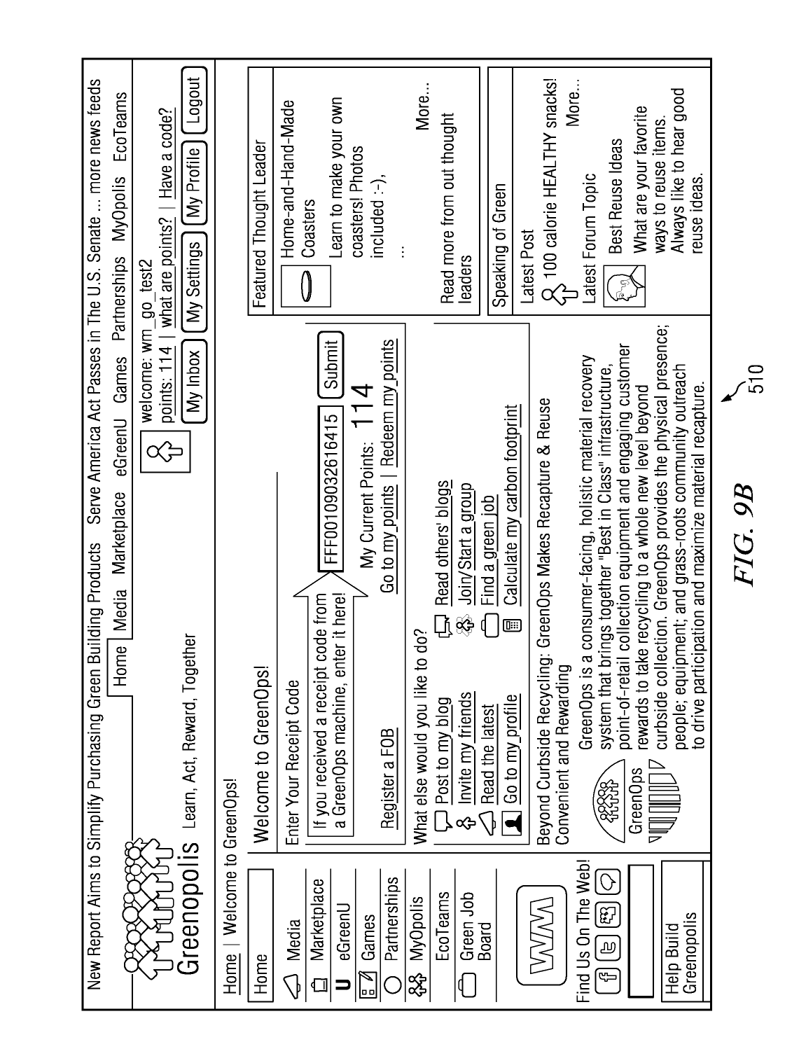

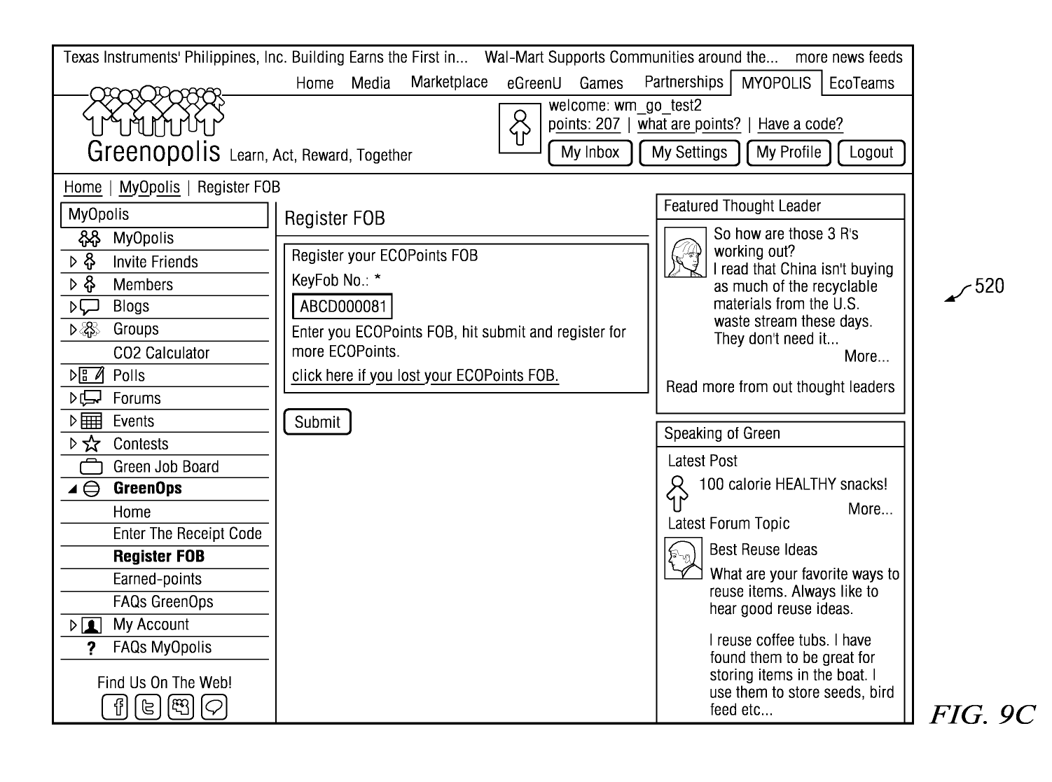

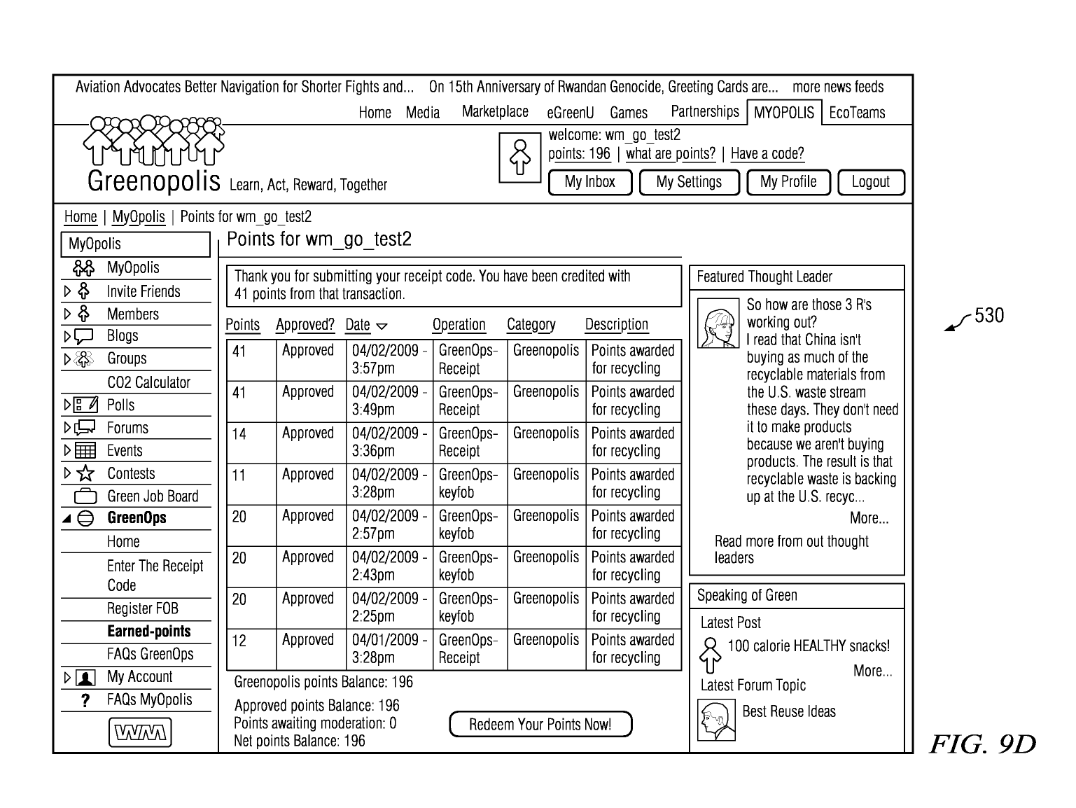

Referring to FIGS. 9A-9D, block diagrams illustrating one possible implementation of a web-based interface in accordance with an embodiment of the present invention are shown. According to this embodiment, a recycling user logs in to a web server using a web browser using a username and password, as shown in FIG. 9A. The recycling user may manually enter recycling activities associated with the recycling user by entering a receipt code provided at the recycling center or station, as shown in FIG. 9B. If the recycling user has a key FOB, then the recycling user may register the key FOB on the web-based interface, as shown in FIG. 9C. Once the key FOB is registered, any recycling activities associated with the key FOB will automatically be entered for the recycling user. The recycling user may review recycling activities associated with the recycling user and may redeem points associated with the recycling activities, as shown in FIG. 9D.

### III. Recycling Center or Station

The present invention includes a recycling center or station, such as a tracking station, remote kiosk, reverse vending machine and the like, that is designed to be visually engaging to consumers and/or recycling users. The recycling center or station is designed to be easy to use for consumers and/or recycling users and includes multiple marketing and communications opportunities for retailers and brands. The recycling center or station includes one or more receptacles configured to receive the recyclable product. According to at least one embodiment, multiple receptacles are arranged on the recycling center or station to receive different types of recyclable products, such as without limitation, glass, plastic, or metal recyclable products. According to at least one embodiment, the recycling center or station includes a scale to weigh the recyclable product.

The recycling center or station may include a scan engine that is configured to be used by end consumers, and/or by non-consumers, such as manufacturers, re-manufacturers, retailers, and the like for internal purposes. According to at least one embodiment, the engine kernel of the non-consumer configuration may include consumer shells or interfaces as enhancements for public use.

The present invention includes flexible software and hardware components that can interface with consumers at retail or support industrial applications. These software and hardware components were designed to increase recycling and reprocessing rates of any material stream that uses coding mechanisms and support industrial control systems to sort materials in a deeper manner to potentially create cleaner and higher value materials streams for enhanced reprocessing and reuse. According to at least one embodiment, the software and hardware components include a graphical user interface accessible to retailers, manufacturers, consumers and/or recycling users that may be used to track the stage of the item or provide other information relevant to such item. According to other embodiments described below, the user may also access the graphical user interface at a recycling center or station, such as a tracking station, remote kiosk, reverse vending machine and the like. The graphical user interface may be used to display information about the recycling activity and/or otherwise communicate with the recycling user.

According to at least one embodiment, the recycling center or station includes the ability to identify the recyclable product. Such identification may be by means of scanning a unique barcode, tag, number, RFD or the like, on the recyclable product. Such identification may also be by other means such as the product weight.

The recycling center or station may optionally include one or more cameras or other optical devices. The one or more cameras may be used to capture an image of the recyclable product. The captured image may be processed in near real-time in order to identify the type of recyclable product using fuzzy logic to match images of known products stored in a database with the captured image. For instance, this technique may be used where the unique identifier has been removed or is obscured and is unable to be scanned normally. According to one embodiment, the captured image may be used to verify the type or number of recyclable products. Alternatively, a captured image of the recyclable product may be stored in a database and associated with the unique identifier.

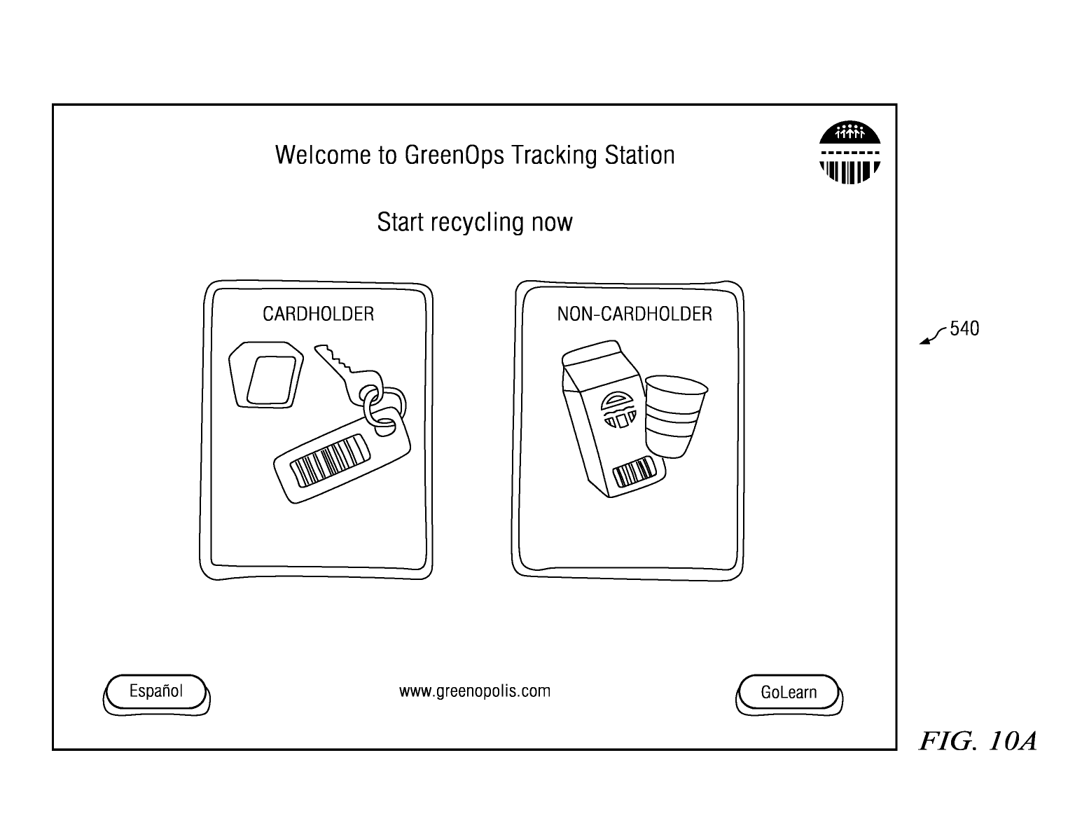

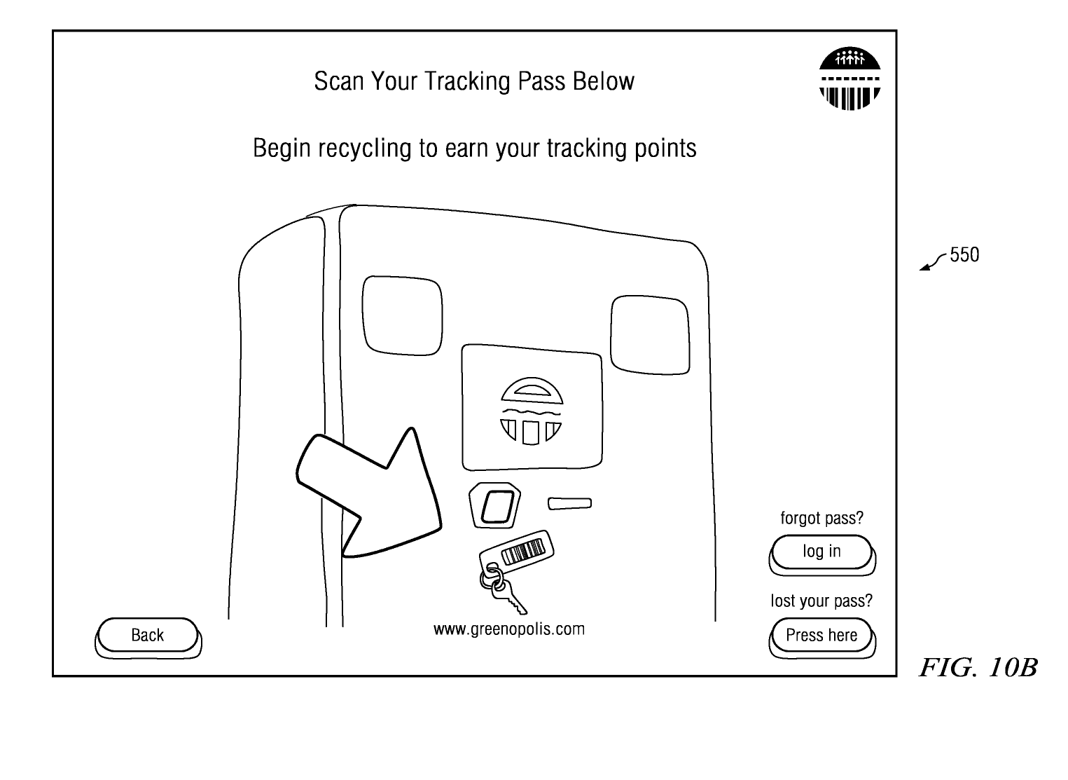

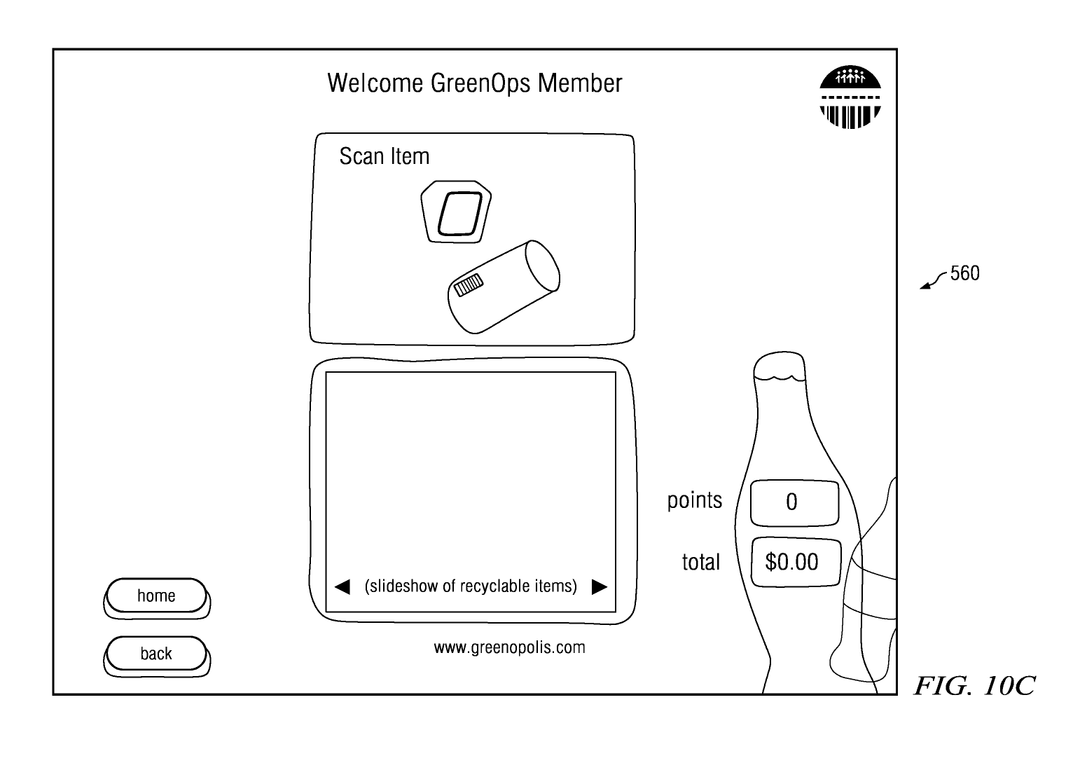

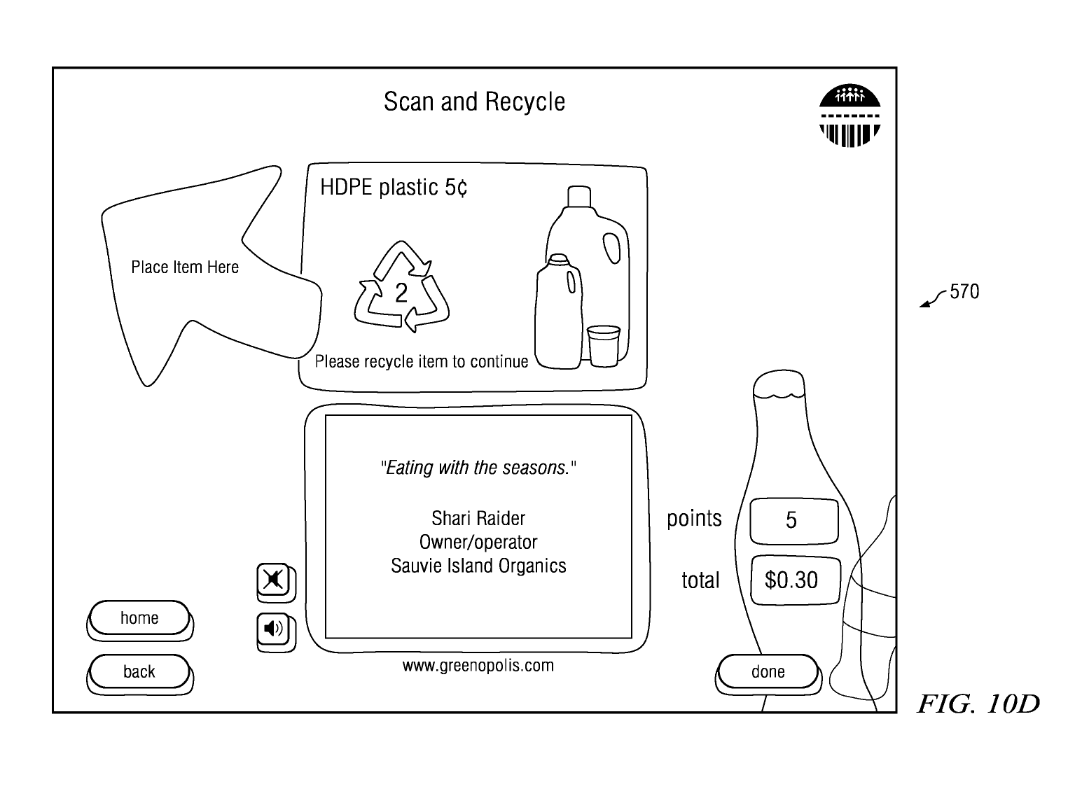

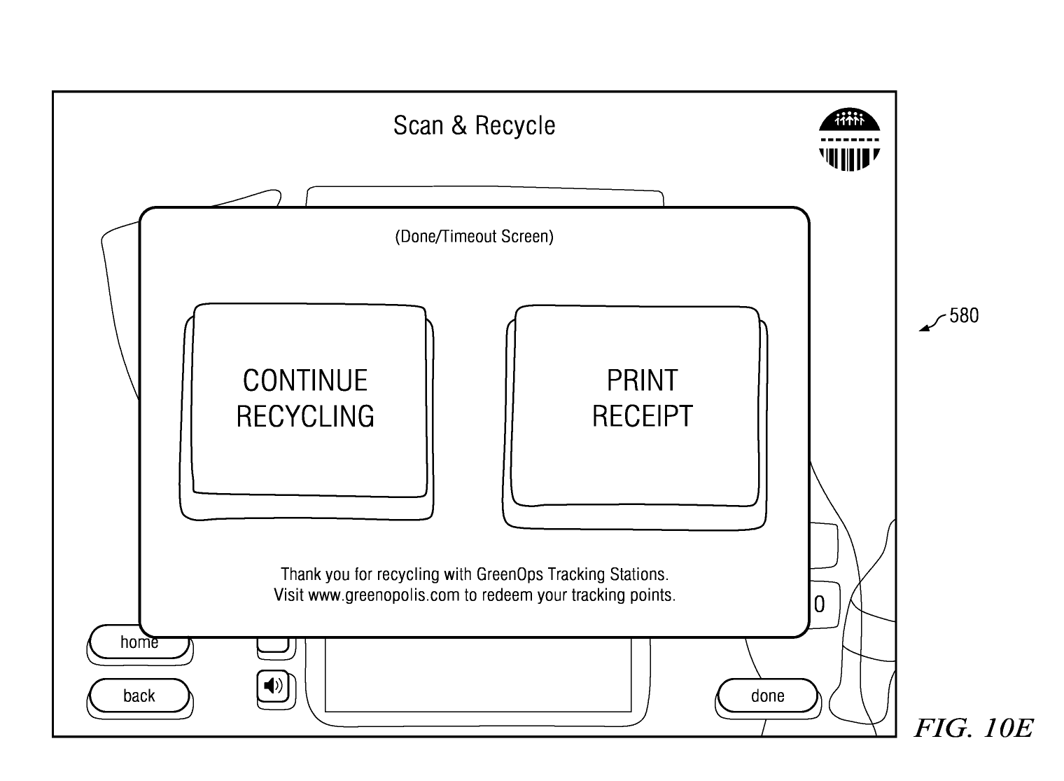

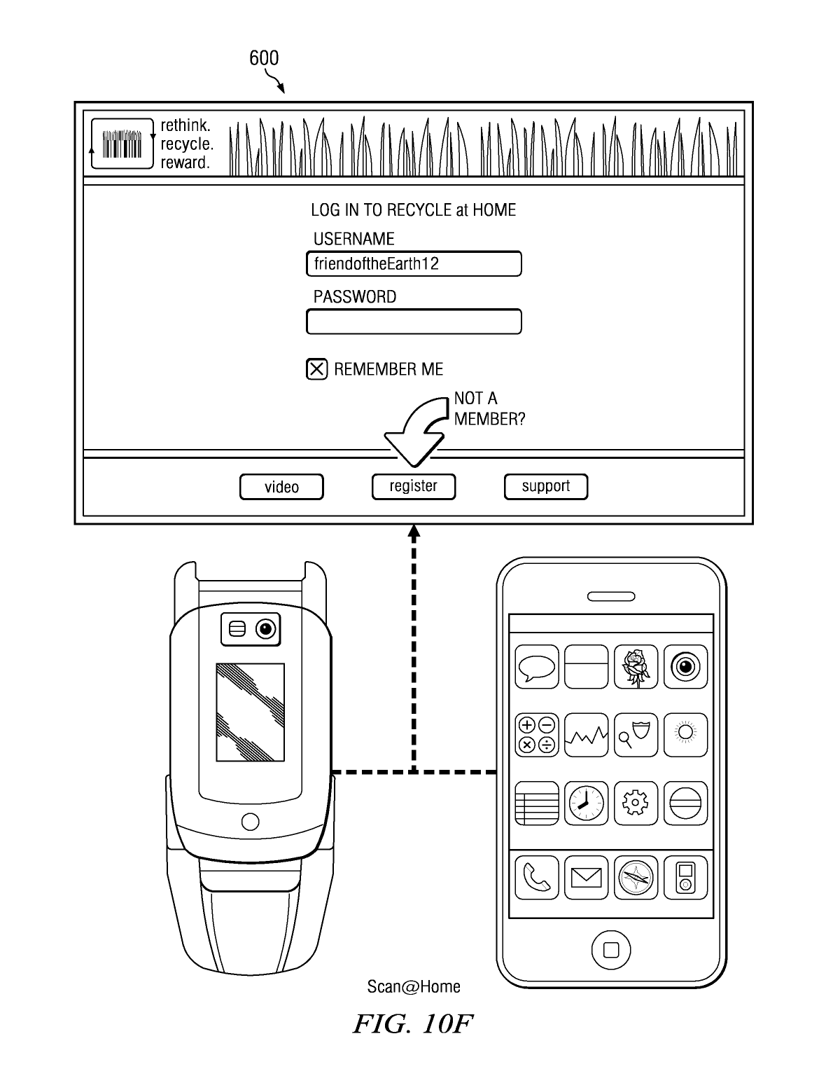

Referring to FIGS. 10A-10E, block diagrams illustrating one possible implementation of a recycling center or station interface in accordance with an embodiment of the present invention are shown. According to this embodiment, a recycling user may either access the recycling center or station as a card holder or a non-cardholder, as shown in FIG. 10A. If the recycling user is accessing the recycling center or station as a card holder, then the recycling user is prompted to scan a key FOB associated with the recycling user, as shown in FIG. 10B. The recycling user scans one or more recyclable products using the interfaces shown in FIGS. 10C-10E. The recycling user may print a receipt of the recycling user's recycling activities, as shown in FIG. 10E.

### IV. GOTRACKER

The present invention includes a tracking module that allows a recycling user to track recycling activities at recycling center or station, such as a tracking station, remote kiosk, reverse vending machine and the like, at home or in other recycling environments. According to at least one embodiment, the tracking module is implemented as a mobile device software application. The mobile device software application may be configured to run on any mobile device, such as without limitation, an Apple iPhone, a Google Google G! Phone, a Blackberry phone, a Palm Treo, or any other portable computing device, such as a general cell phone or a PDA. The mobile device software application is available for download from an app store, a web site or other electronic means. The mobile device software application is configured to operate using any known communication system, other systems, cell networks and the like.

The tracking module provides support for a displaying or otherwise communicating a unique identifier, including without limitation, an RFD, a virtual key fob, an image, a number or a barcode. The image, number or barcode may be displayed on a graphical display of the mobile device. According to one embodiment, the barcode represents a universal product code (UPC). The unique identifier may be used by a recycling user to identify the user, at home, at retail locations and/or during recycling activities at home or a recycling center or station, such as a tracking station, remote kiosk, reverse vending machine and the like. The virtual key fob or UPC barcode may be used by a recycling user to engage consumers and initiate user activity at a recycling center or station. The barcode can also be used for use at a recycling center or station or at retail locations for purposes of loyalty and discount value programs.

As is well known by those of ordinary skill in the art, a key fob is a small hardware device with a built-in authentication mechanism. Just as the keys held on an ordinary key chain provide access to the owner's home or car, the mechanisms in the key fob control access to services and information. Key fobs and other devices, such as smart cards, provide authentication which authenticates the user as the device's owner. The key fob may require the user to provide a personal identification number (PIN), which authenticates them as the device's owner; after the user correctly enters their PIN, the device displays a number which allows them to access services.

According to at least one embodiment, a recycling user is associated with a unique UPC barcode. According to one possible implementation, the recycling user logs in over a network to a server having access, either directly or indirectly, to a plurality of high-resolution UPC barcode images. The recycling user logs in to the server using a username and password, or other security mechanism. A personal high-resolution UPC barcode image is then downloaded and the tracking module displays a personal high-resolution UPC barcode image on the screen of a mobile device. The mobile device may be without limitation an Apple iPhone, a Google Google G! Phone, a Blackberry phone, a Palm Treo, or any other portable computing device, such as a general cell phone or a PDA. Alternatively, the recycling user downloads the tracking module as an application, such as via an app store, a web site or other electronic means, and the tracking module downloads the high-resolution UPC barcode image.

According to an alternative embodiment, a recycling user is associated with a unique virtual key fob. According to one possible implementation, the recycling user logs in over a network to a server having access, either directly or indirectly, to a plurality of virtual key fob data. The recycling user logs in to the server using a username and password, or other security mechanism. The virtual key fob data is then downloaded and the tracking module communicates information as virtual key fob using the communication capabilities present on a mobile device.

Referring to FIG. 4B, a flow chart illustrating a method for tracking recyclable users in accordance with an embodiment of the present invention is shown. At block 222, a user identifier is assigned to a recyclable user and stored in database 16 on sever 14. The user identifier includes without limitation a unique database key field in a database table. The user identifier is associated with a portable identifier at block 224. Portable identifiers include without limitation images, numbers, codes, barcodes, RFIDs, virtual key fob codes, or the like. The portable identifier may be generated upon demand. At block 226, information associated with the portable identifier is stored in a database record associated with the user identifier. This information may include the mobile identifier itself, or other information associated with, or used to retrieve, the mobile identifier. A tracking module is downloaded to a mobile device at block 228. This download may be accomplished by any means including without limitation a recyclable user logging in to a server and selecting to download the tracking module over a network. Downloading the tracking module may include downloading the mobile identifier that is associated with the recyclable user. Alternatively, the mobile identifier may be downloaded over a network separately or via a different server. At block 230, the tracking module is executed on the mobile device. The tracking module either displays the mobile identifier on the display of the mobile device or otherwise communicates the mobile identifier using the communication capabilities of the mobile device at block 232. At block 234, the mobile identifier is scanned or otherwise received by a recycling center or station, and the recycling user is identified by locating the user identifier associated with the portable identifier in the database. The recycling activity associated with the recycling user is tracked using the user identifier at block 236. Thereby, the recycling activities of the recyclable user may be tracked without requiring the recyclable user to manually enter an identifier.

### V. GOSCAN

The present invention includes a scanning module that allows a recycling user to scan and review recycling activities from home and to engage consumers and initiate user activity at retail locations, at recycling centers or stations, at home or in other recycling environments. According to at least one embodiment, the scanning module is implemented as a mobile device software application. The mobile device software application may be configured to run on any mobile device, such as without limitation, an Apple iPhone, a Google Google G! Phone, a Blackberry phone, a Palm Treo, or any other portable computing device, such as a general cell phone or a PDA. The mobile device software application is available for download from an app store, a web site or other electronic means. The mobile device software application is configured to operate using any known communication system, other systems, cell networks and the like.

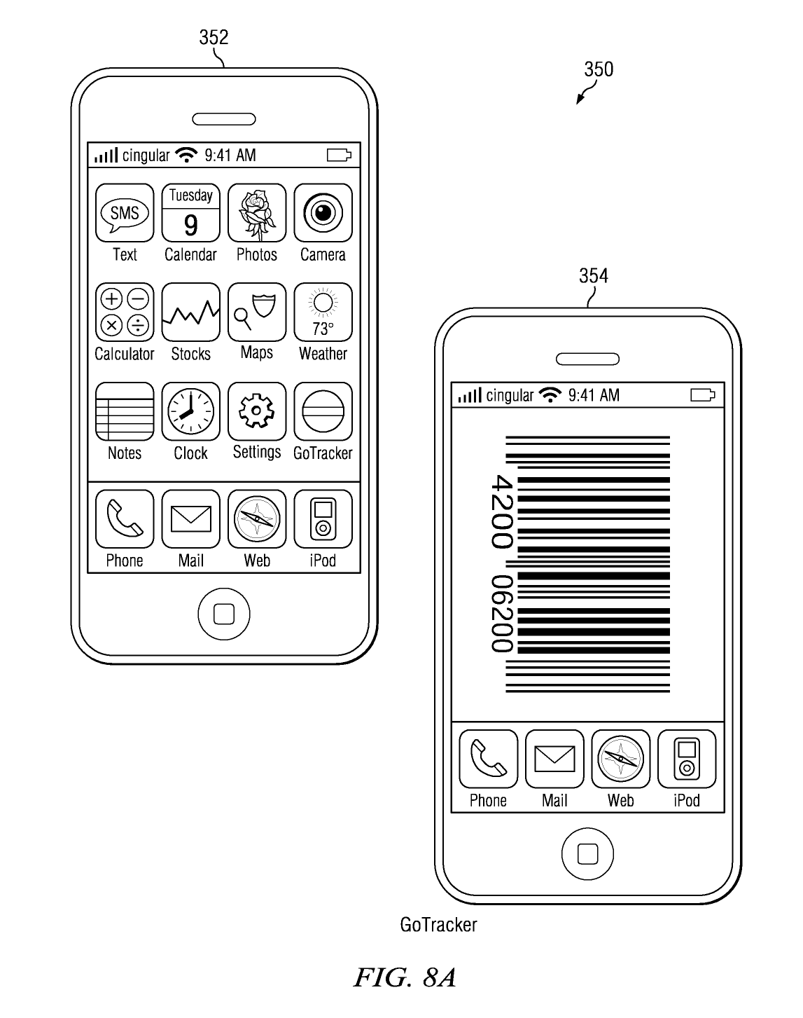

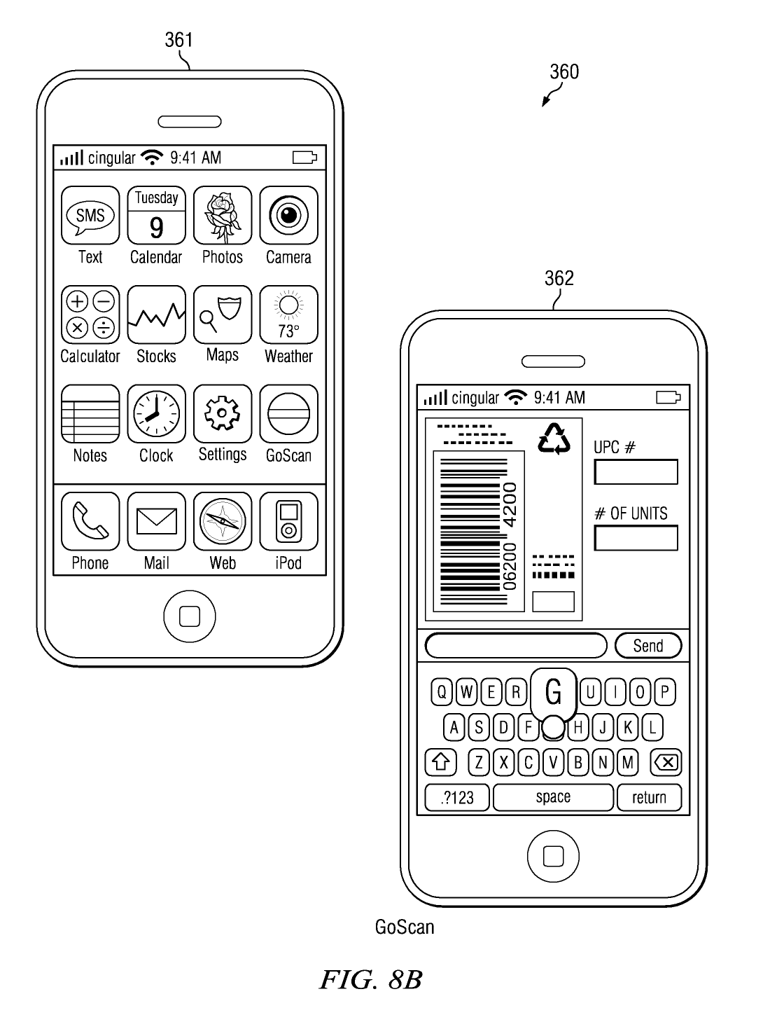

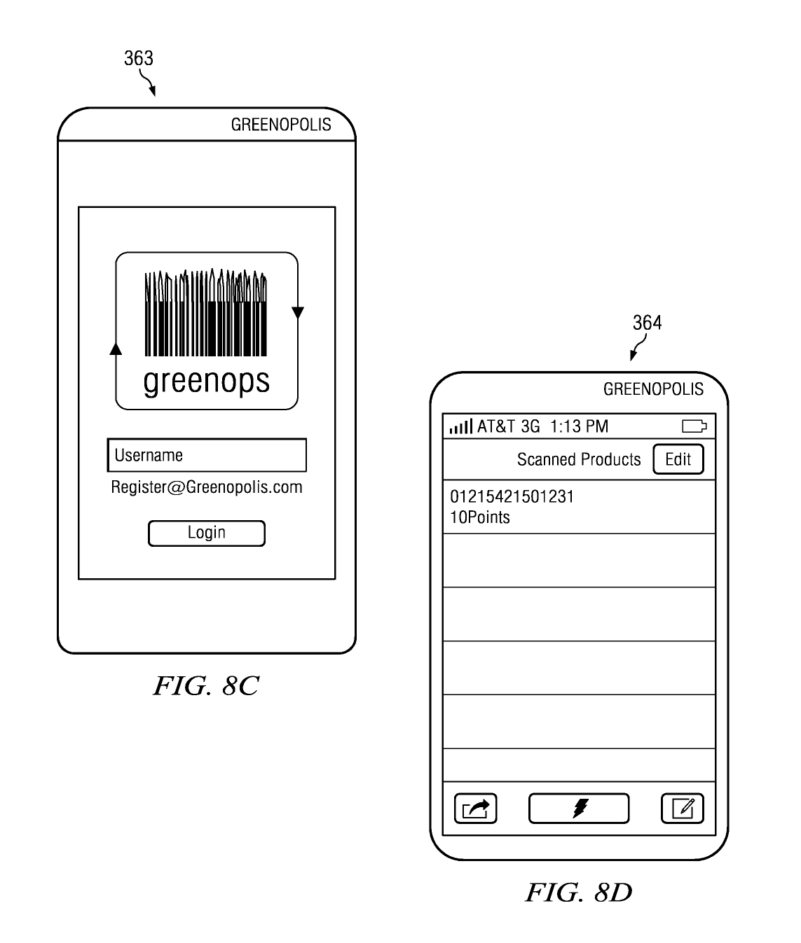

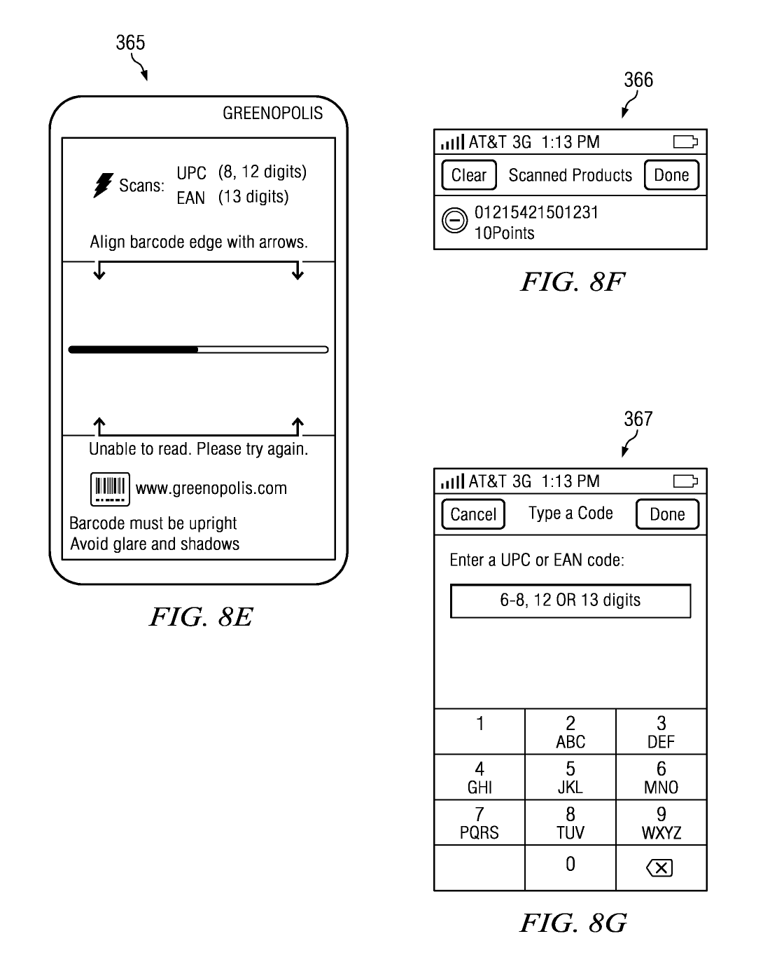

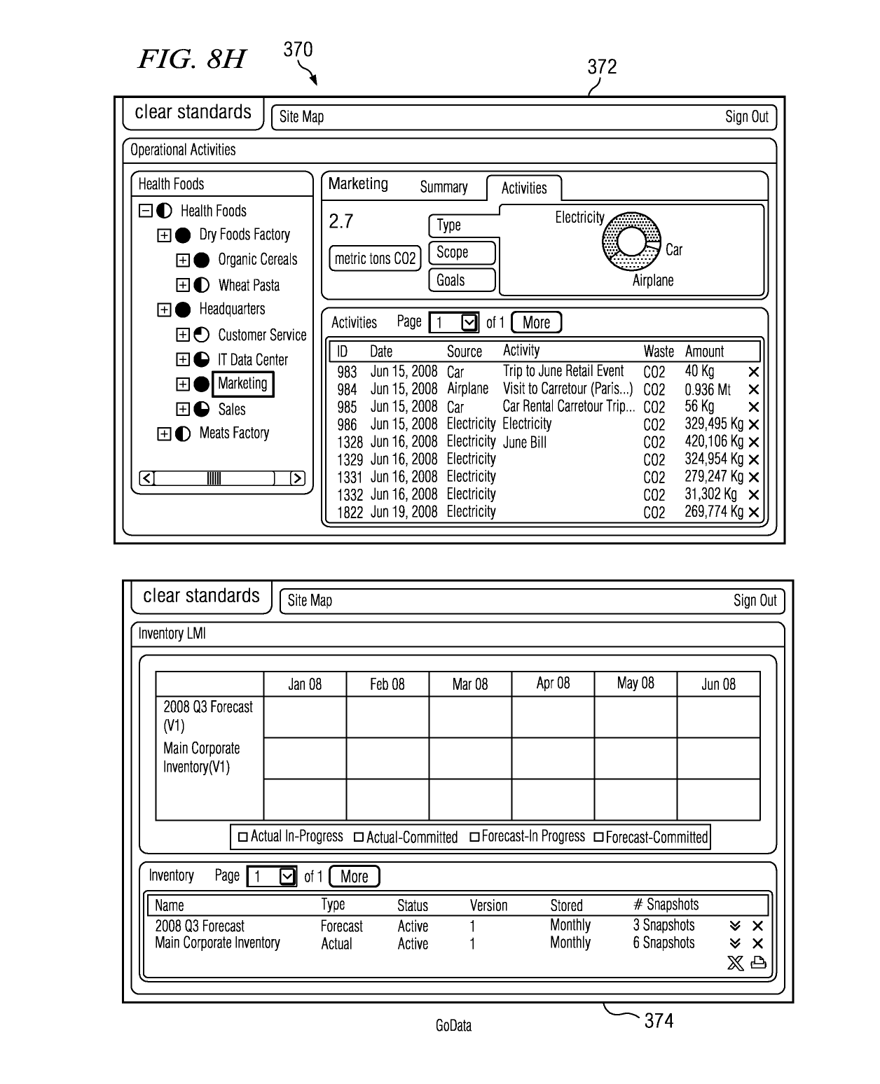

Referring to FIGS. 8C-8G, block diagrams illustrating one possible implementation of a scanning module implemented by a mobile device that is used to scan and review recycling activities in accordance with an embodiment of the present invention, is shown. According to this implementation, the recycling user logs in over a network to a server. The recycling user logs in to the server using a username and password, or other security mechanism. The recycling user downloads the scanning module as an application on a mobile device. Upon execution, the scanning module allows consumers at home to image and account for their home recycling by UPC, brand, or the like. Recycling activities are communicated to a server, such as without limitation a web server, over a network. Recycling activities may be converted to points for later redemption or charitable giving. Recyclable products put into recycling bins at curbside for collection. In certain collection route areas, the recyclable products are weighed and further point acquisition would occur by route or by weight divided by the number of homes or apartments in the route. In other collection route areas, consumers could still live in the WM world and derive points through their activities.

As shown in FIG. 8C, upon execution, the scanning module prompts the recycling user to login. The recycling user is prompted to provide an existing username and password or to register for a new account. As shown in FIG. 8D, the recycling user is presented with all previously scanned items and the reward points earned for each scanned item. Optionally, the recycling user may edit or delete scanned item entries. The user may scan recyclable materials using the scan screen shown in FIG. 8E. The scan screen allows the recycling user to capture the UPC, brand, or the like from the recyclable product. Based on the scan, the recyclable material is identified and reward points are added to the recycling user's reward point total. If the recyclable product is not identified, then the recycling user is prompted to either rescan the recyclable product or to manually enter information associated with the recyclable material as shown in FIG. 8G.

### VI. GODATA

The present invention includes a scoring module that allows a recycling user to quantify recycling activities individually or as a group from various points of view, including without limitation, (i) gross reductions in carbon, green house gases, energy, petroleum, and the like, (ii) net reductions by comprehensive procurement guidelines (CPG) program, retailer, material, product category, and the like, (iii) net reductions by individual, demographic, zip code, state, redemption or non-redemption, and the like. The scoring module is configured to create a supply chain scorecard in support of a recycling business model and consumer recycling program at retail locations, at home, at stadiums, at recycling centers or stations, and the like. Referring to FIG. 8R, a block diagram illustrating one possible implementation of a web-based recycling scorecard in accordance with an embodiment of the present invention is shown. According to this implementation, a supply chain scorecard is displayed in support of a recycling business model and consumer recycling program at retail locations, at home, at stadiums, at recycling centers or stations, and the like,

### VII. GOINDUSTRIAL

The present invention includes the ability to integrate into materials recovery facilities (MRFs) or recycling centers or stations, material scanning control systems to further sort single, duel material streams or in support of product breakdown environments. According to at least one embodiment, various industrial control systems are interfaced to authenticate the capture and sort of various material streams. The data captured by this interface may be used for reporting based upon route logistics, material streams, CPG, consumer versus commercial and other data, along with and reports valued by the recycling entity, its partners, federal and state governments and consumer groups. The interface without limitation utilizes existing technologies, such as UPC, symbol, material, shape and other in place technologies. Existing line control systems, including magnetic, air and vibratory technologies are interfaced to sort deeper into material requirements and create cleaner end streams. The present invention provides greater sorting capabilities to the materials recovery facilities (MRFs) or recycling centers or stations because the detailed database information is available with respect to the particular recyclable product including its type, composition and content, once the recyclable product is identified. This detailed information may be used to provide additional sorting or routing capabilities.

Referring to FIG. 4F, a flow chart illustrating a method for receiving a recyclable at a materials recovery facility or a recycling center or station product in accordance with an embodiment of the present invention is shown. At block 332, the recyclable product is received at the materials recovery facility or the recycling center or station. Typically, this involves receiving co-mingled recyclable products from a recycling or collection vehicle and placing the recyclable products on a moving conveyor belt, which distributes the material for inspection and separation. The recyclable product is identified at block 334. The identification may be performed by scanning a UPC, symbol, material, shape and other in place technology. The recyclable product may be scanned using without limitation a scanner, sensor, receiver, camera or the like. At block 336, the type of recyclable product is determined. Determining the type of product may include use of magnetic, air and vibratory technologies to sort deeper into material requirements. The type of recyclable product may also be determined using without limitation a scanner, sensor, receiver, camera or the like. For instance, a determination of whether the recyclable product is a bio hazard or non-bio hazard may be performed at this step. The recyclable product may also be sorted by without limitation PET/PE color, or based on whether it is organic or non-organic. The recyclable product may optionally be routed to an appropriate processing location based on the type of recyclable product, at block 338.

### VIII. GOLEARN, GOFAQ and GOCHAT

In at least one embodiment, the tracking station includes a support module that is configured to provide recycling users with technical, support and/or other information about the tracking station via a graphical user interface on the tracking station.

Without limitation, the support module may be configured to provide educational videos or audio, answers to frequently ask questions (FAQs), and live video or audio chat sessions with a call center.

Educational videos or audio are provided by the support module based on different categories, including without limitation, age, grade for use by classrooms, individuals and community groups to distribute information about recycling, the environment, sustainability and other eco subjects. According to this embodiment, the graphical user interface provides the ability for consumers, children and others an interactive education based upon the program. Video content is sorted by grade for children and by subject for consumers. In a preferred embodiment, a button on the tracking station initiates a learning video.

Answers are provided by the support module to frequently ask questions (FAQ). According to this embodiment, the graphical user interface provides the ability for a recycling user to receive answers to frequently ask questions. In a preferred embodiment, a button on the tracking station initiates a FAQ session. The answers to frequently asked questions may be provided by any means, including without limitation via a video playback of answers, audio playback or text displayed on the graphical user interface.

Live chat sessions with a call-in center are provided by the support module to provide interactive answers to questions, such as how to use the system, from an expert or otherwise knowledgeable person. According to this embodiment, the graphical user interface provides the ability for a recycling user to initiate a video based chat between consumers at the tracking station with customer service personnel located at a call center. In a preferred embodiment, a button on the tracking station initiates a video chat with call center personnel. This button give consumers, children and others an interactive question and answer process to learn about the GreenOps program and help them use tracking stations and interface with Greenopolis.

Referring to FIG. 4E, a flow chart illustrating a method for interacting with a recycling user using a recycling center or station in accordance with an embodiment of the present invention is shown. At block 292, a graphical user interface is displayed on a recycling center or station.

According to one embodiment, the recyclable user is prompted to enter a user identification. The recyclable user may enter the user identification manually using the graphical user interface or a keyboard. The recyclable user may also enter the user identification via a key FOB, mobile identifier or the like. At block 296, the user identification is used to locate a user account in a database. The database may be physically located on the recycling center or station or may be located on a central server and the user identification is communicated to the central server via a communication network. If the user account is not located, then the recyclable user may be optionally prompted to enter information to add a new user account in the database at block 298. Otherwise, an error message is displayed to the recyclable user. At block 300, the user account is retrieved from the database. According to an alternate embodiment, blocks 294-300 are not performed and processing continues to block 302.

At block 302, one or more menu options are displayed on the graphical user interface. The one or more menu options include without limitation (i) managing at least a portion of the information associated with the user account (block 302); (ii) displaying one or more FAQs about the recycling center or station, recycling generally, or about environmentally friendly programs in which the recycling user may participate (block 304); (iii) displaying or listening to a educational video or audio file, respectively (block 306); (iv) redeeming or transferring reward points associated with the recyclable user (block 308); and (v) initiating a live video or audio chat session with a representative at a call center (block 310). Each of the above menu options are processed at blocks 312-320.

### XI. Custom Tracking Stations

The present invention includes a tracking station that is configured to handle numerous types of recyclable products, including without limitation, medical waste, consumer electronics, shoes, clothing, digital video discs (DVDs), compact discs (CDs), appliances, magazines and the like. The tracking station includes a baseline capture engine for other market opportunities and potential integration of capture engine into other third party equipment.

### XII. Recycling Vehicle Collection

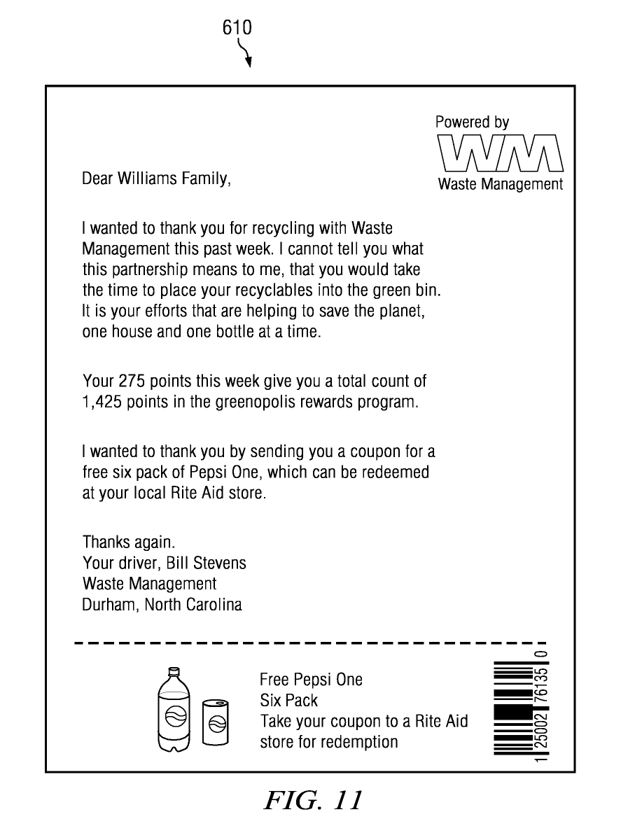

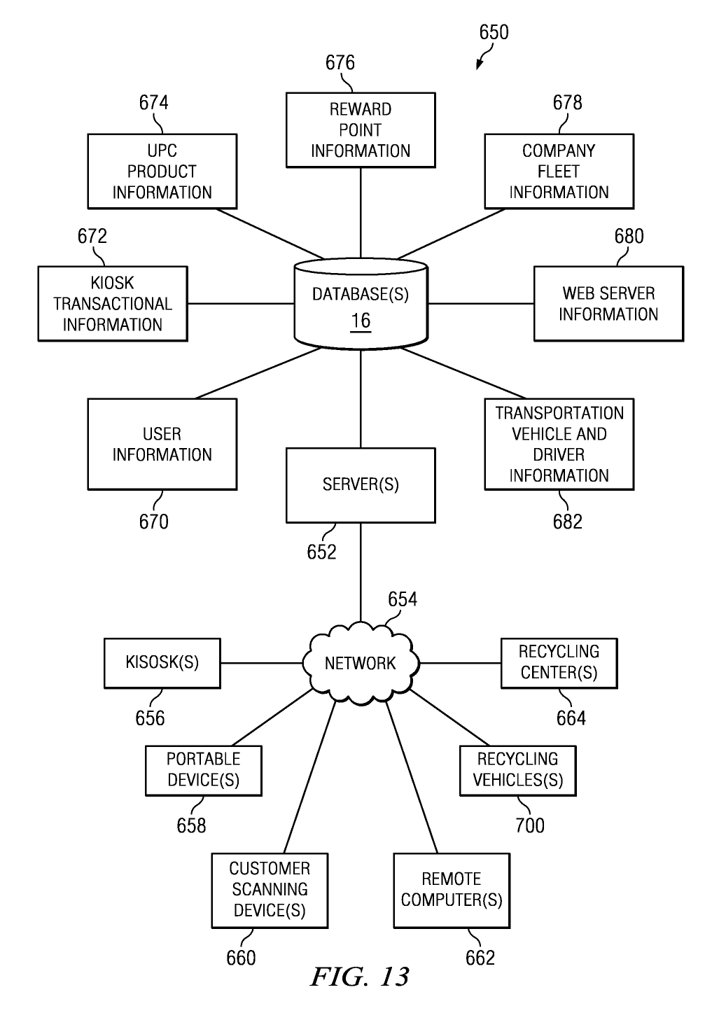

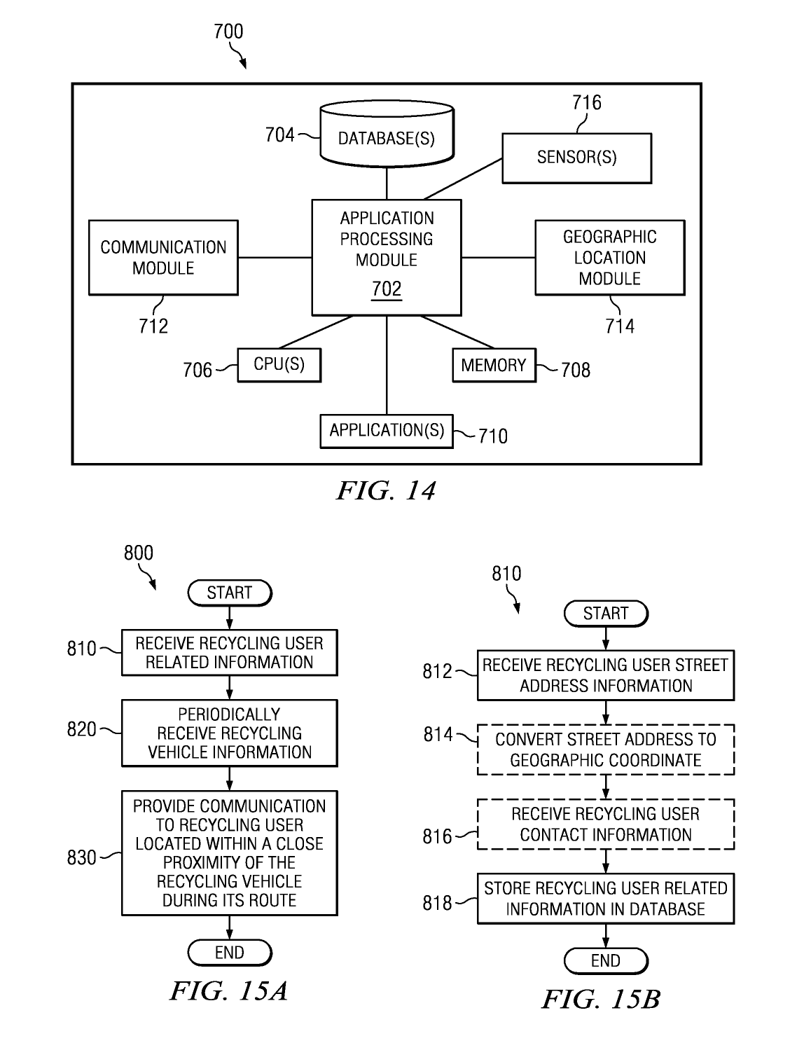

The present invention includes a system and method for communicating with recycling users while their recycling materials are collected. Referring to FIGS. 13 and 14, a system for connecting recycling users with various recycling activities, and improvements to a recycling vehicle are shown, respectively, in accordance with an embodiment of the present invention. According to one embodiment, a wireless network-based system connects the above-described rewards system, a recycling vehicle 700 and one or more recycling users along the route of the recycling vehicle. Recycling based rewards, coupons and/or electronic communications are communicated to recycling users in at least near real-time as recycling vehicles drive along their daily routes. For example, the electronic communication may be, without limitation, the communication shown in FIG. 11. The recycling vehicle 700 directly or indirectly includes, without limitation, a communication module 712, a geographic location module 714, and an application processing module 702. These modules (702, 712, 714) may be separate or integrated into a single device, such as a PDA, EDA, laptop computer, tablet, cellular phone, or the like. Devices comprising one or more these modules, or portions thereof, may be integrated into the recycling vehicle 700 itself, or may be entirely mobile and carried by the driver.

The application processing module 702 includes one or more computer processing units (CPUs) 706 that execute one or more software applications or apps 710. The application processing module 702 may be in communication with one or more local databases 704 and memory 708 having recycling related information and sensor information collected during the route of the recycling vehicle 700.

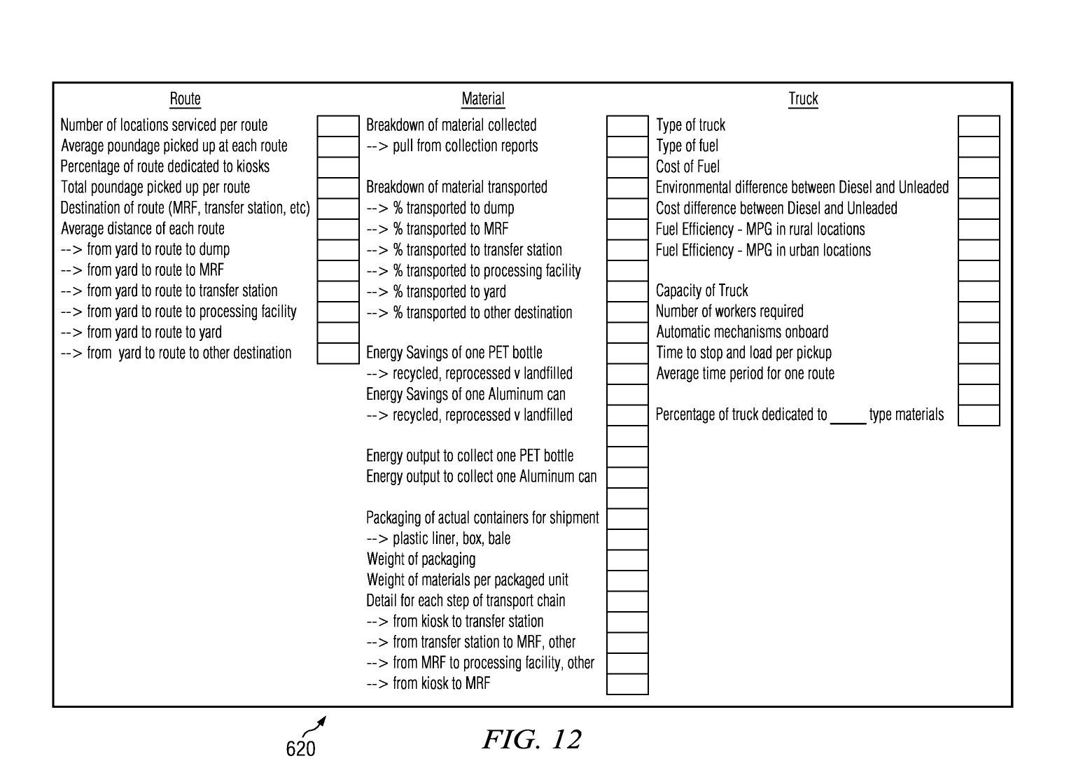

According to one embodiment, the recycling vehicle is configured with one or more sensors or input devices 716 including, without limitation: a weight scale or sensor to determine the weight of the recycling vehicle or its payload; a motion sensor to determine when the recycling vehicle is in stationary or in motion; a real-time clock or timer for determining when recycling vehicle arrives a certain predefined or configurable geographic locations; a speed sensor for periodically monitoring the speed of the recycling vehicle; a mileage sensor for periodically monitoring the number of miles driven by the vehicle; a camera or video device for periodically capturing images of the recycling materials, bins or other recycling related activities along the recycling route; a keyboard or data entry device for manual input by the driver. As shown in FIG. 12, the recycling vehicle and/or the MRF may be configured to also receive, without limitation: the number of locations serviced per route; the weight of the recyclable materials picked up at each route; the distance of each route; and the volume of different types of recyclable materials collected.

The communication module 712 supports wireless network-based communication directly or indirectly between the recycling vehicle 700 and at least one or more remote computer servers. The wireless network-based communication may utilize any known or future networking protocol, including, without limitation, WIFI, LTE, WiMAX, Bluetooth, and the like within the scope of the present invention.

The recycling materials may be identified prior to pick up using one or more home-based scanning devices 652 or other data entry, such as manual data entry. The home-based scanning 652 may include, without limitation, a UPC scanning, barcode scanning, or recognition of products photographed by portable devices, such as a camera or cell phone.

The recycling user receives coupons, rewards or other consideration for the recycling user's participation in the recycling program. According to one embodiment, the reward, coupon and/or electronic communication delivery is automated and occurs automatically when the recycling vehicle is within close proximity of the recycling user's geographic location. Alternatively, the reward, coupon and/or electronic communication is delivered when the recycling vehicle driver manually initiates the delivery to a recycling user.

According to one embodiment, the geographic cation module 714 resides in one or more devices and determines the geographic location of a recycling vehicle in at least near real-time during its pickup activities. Any device capable of determining the geographic location of the recycling vehicle may be utilized, including, without limitation, global positioning satellite (GPS) systems, wireless systems that utilize triangulation of communication towers to determine the location, such as cellular-communication triangulation, and the like. For instance, according to one embodiment, the geographic location module 714 is a software application and related hardware residing on, without limitation, a Motorola Global ES400 EDA or similar communication device with GPS or other geographic location determination capability.

Using the geographic location module 714 in communication with a rewards-based system described above, a reward, coupon and/or electronic communication is delivered to a recycling user when the recycling vehicle is in close geographic proximity to the recycling user. For instance, a personalized gift may be communicated to a recycling user when the recycling vehicle is picking up the recycling materials from the recycling user's home. Alternatively, an electronic announcement, such as an email, text message, web page link or the like is delivered. Thereby, the presence of the recycling vehicle may be announced via the coupon, reward, or electronic announcement, such that a brand loyalty associated with the recycling company may be improved.

According to at least one embodiment, the system includes two major components: a geographic location module 714 located in or on the recycling vehicle in communication with recycling rewards system as described above, and a coupon push technology emanating from a network-based server. The geographic location module 714 resides in a GPS or cellular device located in or on the recycling vehicle.

One or more software applications 710 in communication with the application processing module 702 is used to receive the geographic location of the recycling vehicle and to communicate that location to a recycling rewards system in at least near-real time. The type of device in which the geographic location module 714 resides and the type of software application 710 is not intended to be limited by the present invention. For instance, a small software app 710 residing in a Windows Mobile environment may be utilized. The software app 710 in communication with a geographic location module, using GPS positioning or other means, communicates with the rewards network as the recycling vehicle travels its daily route. The geographic location information is matched to the physical street address of a recycle user.

A web-based graphical user interface is provided to the above-described rewards system such that the recycling user may enter the recycling user's physical street address. Such information may also be provided from other sources, such as from a third party database. The street address or other geographic location is stored in a database 16 associated with the recycling user.

As is known in the art, geocoding is the process of converting a street address to a GPS coordinate. Reverse geocoding is the process of taking GPS coordinates and converting them to street addresses. The present invention may utilize geocoding and/or reverse geocoding to determine the geographic location of the recycling user. According to one possible implementation, the GPS coordinate is determined based upon the street address using geocoding and stored in the database. A GPS coordinate received from the geographic location device is then compared against the geocoded GPS coordinate stored in the database in order to match the GPS coordinate with a recycling user's account. According to another possible implementation, the street address of the recycling user is stored in the database and geocoding or reverse geocoding is utilized in near real-time before matching the GPS coordinate with a recycling user's account. The database may be searched by any known means including, without limitation, an SQL query or the like. Based upon an account look up for the recycling user, a coupon, reward or other electronic communication may be communicated to the recycling user in at least near real-time. The system may utilize configurable custom business rules in matching the recycling user to geographic location of the recycling vehicle, and in delivering a coupon, reward or other electronic communication to the recycling user. The electronic communication may include a predefined or configurable personalized note from the recycling vehicle driver or other team member of the recycling company. Thereby, over time, the recycling vehicle driver is out from behind the recycling vehicle and into the recycling user's homes. The recycling vehicle driver only has to turn the device on.

According to one embodiment, recycling related information is periodically communicated over a wireless network during the route of the recycling vehicle. This information includes, without limitation: the mileage average of the recycling vehicle; timing information along the route of the recycling vehicle, such as the time when recycling vehicle arrives a certain predefined or configurable geographic locations; the number of recycling bins collected during the route; the weight of the recycling vehicle; the weight of recycling materials based on information entered or scanned by the recycling user; the number of recycling vehicle stops; the low, high and average speed of the recycling vehicle; and the like. This reduces the amount of paperwork that is required to be processed at the end of the day, and reduces the delay in receipt of such information from the field. Further, the tools required to collect and access data, make the best decisions and complete tasks are always available. Thereby, action items become actions taken, delivering the maximum efficiency and rapid response times required to provide extraordinary customer care and service, and increasing enterprise profitability, strength and brand value.

The recycling vehicle may also be configured to include a telemetric capability. This telemetric capability may be integrated into a recycling vehicle, or may be used as a handheld device in or on the recycling vehicle, MRF or other appropriate environment. The communication module 712 in communication with one or more software apps 710 may be configure to communicate recycling vehicle and route efficiency status, recycling vehicle locators, biometric or other sign in requirements and driver communication through phone, SMS and email. Any portable device implementing the modules described in FIG. 14 may be remotely configurable with the ability to receive recycling vehicle data, driver data, route data and/or installer files.

The present invention provides support at least near real time distribution of efficiency data between the recycling vehicle 700, network and MRF. This efficiency data is provided to one or more servers 652 and displayed to a recycling user via a consumer based dashboard on a web-based user interface, such as a corporate web site, greenopolis, TGR, Lamptracker. Using a network of task oriented counters, residential and commercial customer sustainability and environmental strategies are connected to a network of recycling vehicles, MRF's and other recycling assets nationwide using a series of specific customer data metrics in a way never been done before by anyone in the market segment.

Material, poundage, mileage, logistics, human capacity, energy usage/savings are gained in the similar manner a financial institution would use currency to develop sophisticated data modeling. The end result is a carbon footprint analysis that measures human consumption, waste generated and method of pricing integrated into the largest fleet/MRF infrastructure in North America, which could assist a company to increase business and recycling levels.

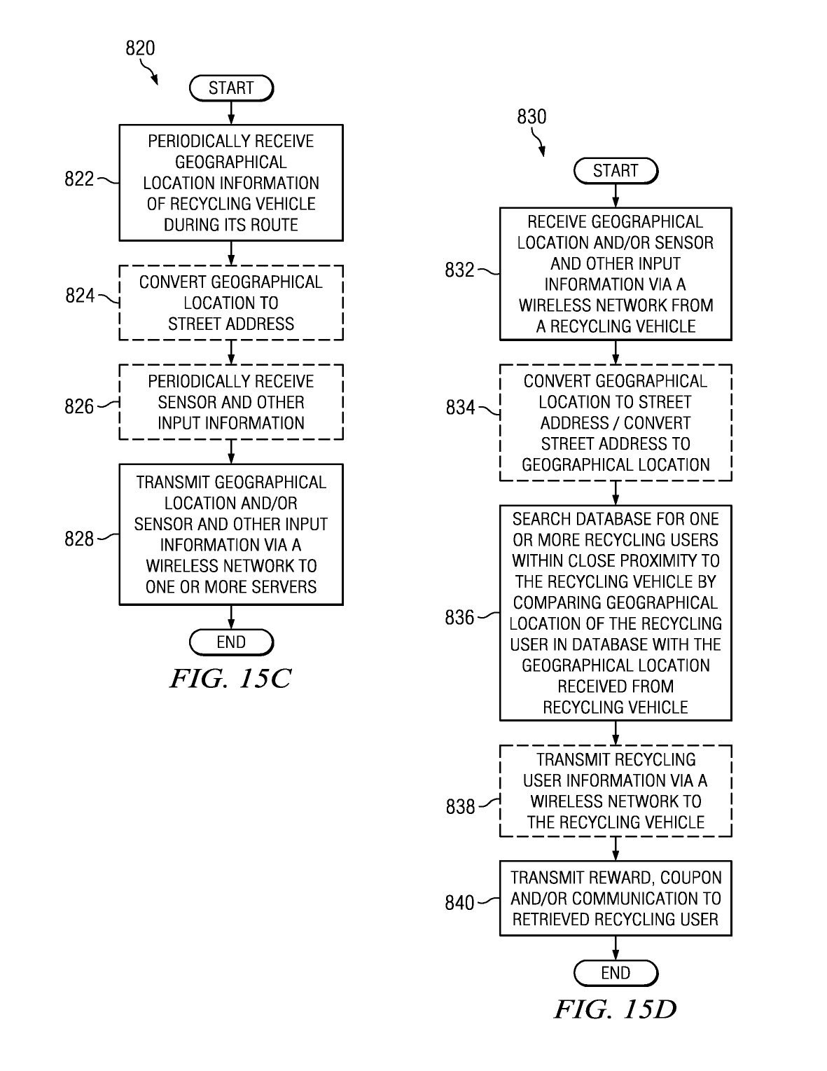

Referring to FIG. 15A-15D, flow charts illustrating a method for communicating with recycling users while their recycling materials are collected by a recycling vehicle in accordance with an embodiment of the present invention is shown. At block 810, certain recycling user related information is received. As shown at block 812, recycling user street address information is received. In one embodiment, the recycling user street address information is manually entered by the recycling user using a web-based user interface during the recycling user's registration to the rewards system described above. Alternatively, the recycling user street address information may be received from any third party databases. Optionally, the recycling user street address is converted to a geographic coordinate using geocoding, as shown at block 814. Such a conversion allows the geographic coordinate of the recycling user to be compared against the geographic coordinate received from the recycling vehicle without requiring additional real-time conversions of the geographical information. However, it is understood that either storing the street address or the geographical coordinate in a database on the server is within the scope of the present invention.

At block 816, recycling user contact information is optionally received from the recycling user. Recycling user contact information includes, without limitation, the email address, text message address or number, twitter address, and the like of the recycling user. Optionally, the contact information includes wireless router, bridge and/or home-networking names, passwords and/or other information. This information may be used to detect a wireless router, bridge and/or home-network of the recycling user when the recycling vehicle is within range. This information may also be used to directly access the wireless router, bridge, printer and/or home-network of the recycling user in order to provide a communication to the recycling user. For instance, a reward, coupon and/or communication may be printed on a printer within the home-network of the recycling user when the recycling vehicle is within proximate range of the recycling user's home-network. For security reasons, this type of communication would need to be expressly authorized by the recycling user. Recycling user contact information may also include opt-in or opt-out options for receiving rewards, coupons and/or electronic communications from the recycling entity and/or recycling vehicle. Thereby, a user may elect to not receive these types of communications while the recycling vehicle is on its route.

The recycling user street address information and/or recycling user contact information is stored in one or more databases 16, at block 818.

At block 820, certain recycling vehicle information is periodically received. As shown at block 822, recycling vehicle information is periodically received from one or more recycling vehicles during their respective routes.

Optionally, the geographic coordinate of the recycling truck is approximately converted into a street address or range of street addresses using reverse geocoding, as shown at block 824. Such a conversion allows the street address of the recycling user to be compared against a converted approximate street address of the recycling vehicle. It is understood that utilizing either street addresses or the geographical coordinates is within the scope of the present invention.

Optionally, sensor and/or other input information is periodically received at block 826. As discussed above, the recycling vehicle may be configured with one or more sensors or input devices 716 including, without limitation: a weight scale or sensor to determine the weight of the recycling vehicle or its payload; a motion sensor to determine when the recycling vehicle is in stationary or in motion; a real-time clock or tinier for determining when recycling vehicle arrives a certain predefined or configurable geographic locations; a speed sensor for periodically monitoring the speed of the recycling vehicle; a mileage sensor for periodically monitoring the number of miles driven by the vehicle; a camera or video device for periodically capturing images of the recycling materials, bins or other recycling related activities along the recycling route; a keyboard or data entry device for manual input by the driver. Optionally, the geographic location of the recycling vehicle and/or sensor and other input information is stored in one or more local databases 704 located on or in the recycling vehicle. The geographical location and/or sensor and other input information is transmitted via a wireless network to one or more remote servers, at block 828. The information stored in one or more local databases 704 may be optionally transmitted at any time to the one or more servers. For instance according to an alternate arrangement, the information stored in one or more local databases 704 is only transmitted by the recycling vehicle at the end of the route.

At block 830, one or more rewards, coupons and/or electronic communication is provided to one or more recycling users within close proximity of the recycling vehicle. As shown in block 832, the geographical location and/or sensor and other input information is received via a wireless network form a recycling vehicle. Optionally, the geographic coordinate of the recycling truck is approximately converted into a street address or range of street addresses using reverse geocoding, as shown at block 834. At block 836, a database search of one or more databases 16 to locate any recycling users within close proximity to the recycling vehicle is performed. The proximate area is configurable and may be predefined.

According to one embodiment, the geographic coordinate of the recycling user to be compared against the geographic coordinate received from the recycling vehicle without requiring additional real-time conversions of the geographical information. According to an alternate embodiment, the street address of the recycling user is compared against the approximate converted street address received from the recycling vehicle without requiring additional real-time conversions of the geographical information.

The recycling user information is optionally transmitted via a wireless network to the recycling vehicle at block 838. This information may include the reward, coupon and/or electronic communication to be transmitted to the recycling user. At block 840, the reward, coupon and/or electronic communication is transmitted to the recycling user. According to one embodiment, the reward, coupon and/or electronic communication is transmitted directly or indirectly from one or more remote servers 652. According to one embodiment, the reward, coupon and/or electronic communication is transmitted directly or indirectly from the recycling vehicle 700.

### XI. Photosharing

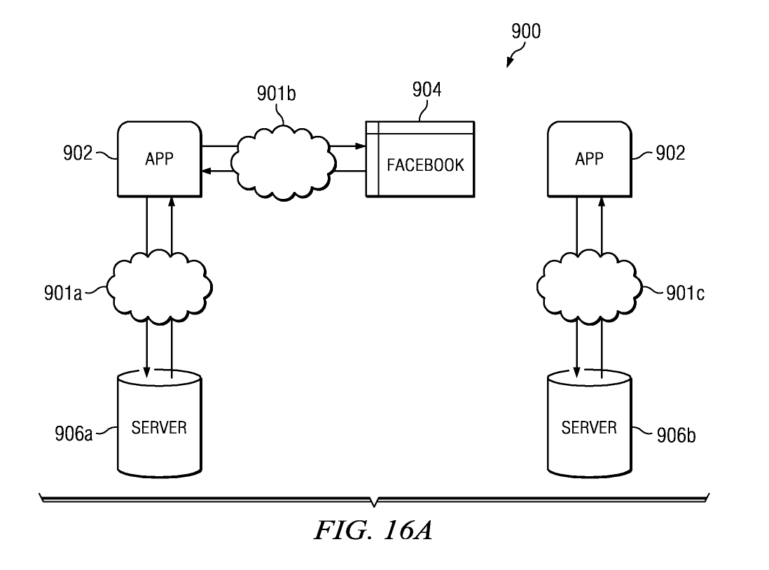

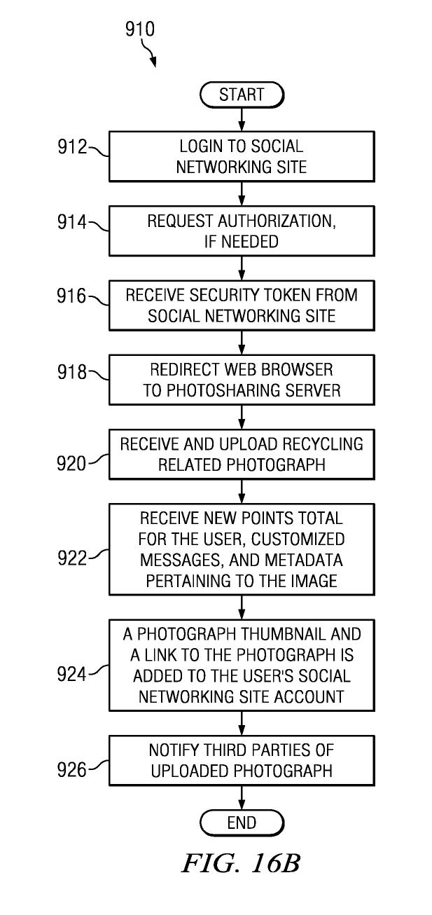

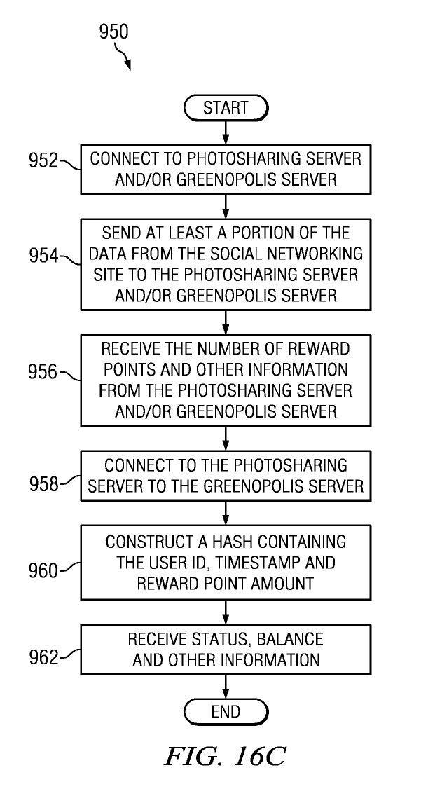

Referring to FIG. 16A, a block diagram illustrating an exemplary arrangement for photosharing recycling related photographs in accordance with an embodiment of the present invention is shown. According to this arrangement, server 906 is a web server, or the like, able to communicate with one or more users via network 901, such as, without limitation, the Internet, an Intranet or other communication network. Device 902 is any computing device that is able to communicate with a social networking site 904 via network 901, such as without limitation the Internet, an Intranet or other communication network.

Server 906 includes a computer with one or more processors and a computer readable storage medium, such as, without limitation, a computer hard-drive, flash-drive, card, removable drive or memory. A computer program having executable instructions may be stored on the computer readable storage medium of server 906. According to one embodiment, the system of the present invention may include multiple servers (e.g., 906a and 906b) in direct or indirect communication there between. For instance, according to one non-limiting environment, the photosharing photographs are stored on a separate photosharing server from the Greenopolis server. Obviously, multiple server or a single server may be used within the scope of the present invention.

Device 902 includes one or more processors and a computer readable storage medium, such as, without limitation, a computer hard-drive, flash-drive, card, removable drive or memory. A computer program or “App” having executable instructions may be stored on the computer readable storage medium of device 902. Device 902 may be any type of computing device, such as, without limitation, a computer, a server, a smart phone, a tablet computer, a handheld computer, a laptop computer, a mobile Internet device or phone, a personal digital assistant (PDA), and the like, within the scope of the present invention. Further, the type of software application is not intended to be limited by the present invention. For instance, a small software App residing in a Windows Mobile environment, a mobile device, a web browser application executed on a server and/or a client computer, or the like may be utilized.

Referring to FIGS. 16B-16C, flow charts illustrating a method for photosharing recycling related photographs in accordance with an embodiment of the present invention, are shown. According to this implementation, the recycling user logs in over a network 901 to server 906, which may be any type of server, including, without limitation, the photosharing server, the Greenopolis server, an Apple iTunes server, a Blackberry server and the like. The recycling user logs in to the server using a username and password, or other security mechanism. The recycling user downloads the photosharing module as an application on device 902. Upon execution, the photosharing module allows users to share recycling related photographs, images, or the like (collectively referred to herein as “photographs”) with third parties over a social networking site. The received photographs are communicated to a server 906, such as without limitation a web server, over a network. The recycling user is then awarded a predetermined number of reward points for later redemption or charitable giving in exchange for sharing one or more photographs. According to other embodiments, the recycling user may also be awarded a predetermined number of reward points for later redemption or charitable giving in exchange for, without limitation: adding a description or otherwise providing information related to the shared recycling photograph; texting, posting or otherwise communicating about recycling activities; and sharing videos, documents or other multimedia related to recycling activities.

The present invention includes a photosharing module that is configured to receive and share photographs relating to recycling activities. The photosharing module is intended to reward recycling users for their recycling activities and motivate others to recycle by making recycling related photographs available to other users of a social networking site and/or the general public. The photosharing module rewards users for taking pictures of what they're recycling, uploading it to a networked computer server and sharing it with friends on social networks, such as, without limitation, Facebook, Twitter and the like. It provides rewards for recycling activities through photosharing.

According to one embodiment, users of the photosharing module are identified by their accounts on a social network site 904, such as Facebook. The first time the photosharing module is started, the user is presented with a pop-up dialog to log in to the social network site 904, such as Facebook. A security token and at least some user data may be stored locally on the user's device 902 such the login phase may be skipped the next time the photosharing module is started.

The photosharing module connects to a server 906 over a network 901, such as the Internet, Intranet, proprietary network or the like, sends a subset of the data retrieved from the social network site and receives a current tally of that recycling user's reward points. Individual messages may be displayed to the user via pop-up dialog message, and other metadata. The on-screen reward points are updated to reflect server supplied totals. Personalized messages may be displayed on the device 902. Metadata may be cached locally on the user's device 902 for later use.

The user may choose to upload either a newly captured photograph or a photograph previously captured that was stored in the device's photo album or otherwise available. Optionally, a geographic location, photo caption, and/or other data may be collected from device 902. The geographic location may be either manually or automatically collected and may be used to designate the location where the recycling activity occurred. For instance, the GPS location or triangulation location of a mobile device could be automatically transmitted along with the other information relating the recycling activities. The geographic location may be optionally shown on a map, such as a Google map or the like, along with a thumbnail or other representation of the recycling related photograph. The data is then uploaded via a network 901, such as the Internet, to server 906.

On the server 906, the image may be resized to various predetermined useful sizes and saved to permanent storage. Any related data uploaded from the device 902 may be saved to a database on the server 906 for future processing, retrieval and publishing.

According to one embodiment, the server 906 sends back to the user's device 902 a new points total for that user, customized messages, and metadata pertaining to the image just uploaded. This metadata is used to prefill and/or automatically submit messages to various social networking sites 904, such as Facebook, Twitter, or the like, to spread awareness of the newly uploaded photograph. The metadata is also used to allow users to send email to other users containing a tailored message and links to the newly uploaded photograph.

Optionally, a scrolling album of photographs previously uploaded by both the user and other users of the photosharing module may be displayed after each upload. Users can click on a small version of a stored photograph and view a larger version with its metadata such as a caption. The user may be presented with buttons to post links to any of these photographs to social networking sites 904 or email links in a manner similar to posting the user's own uploaded photograph.

According to one embodiment, third parties are notified via, a social networking site 908 or via email of uploaded photographs and provided a web link to access the photograph. The third party can click the included web link and visit the server 906 containing the photograph in a web browser. A large version of the appropriate photograph is displayed in the web browser. Buttons, controls or the like may also be displayed in the web browser so that these third party users may themselves also post messages and links to social networking sites.

According to one non-limiting possible embodiment of the present invention, the photosharing module is an App on a mobile device and incorporates HTML5, Javascript, PhoneGap, and native code. The server may include a software application to communicate and respond to the mobile device written in any programming language, such as, without limitation, PHP, ASP, .net, Java, and the like.

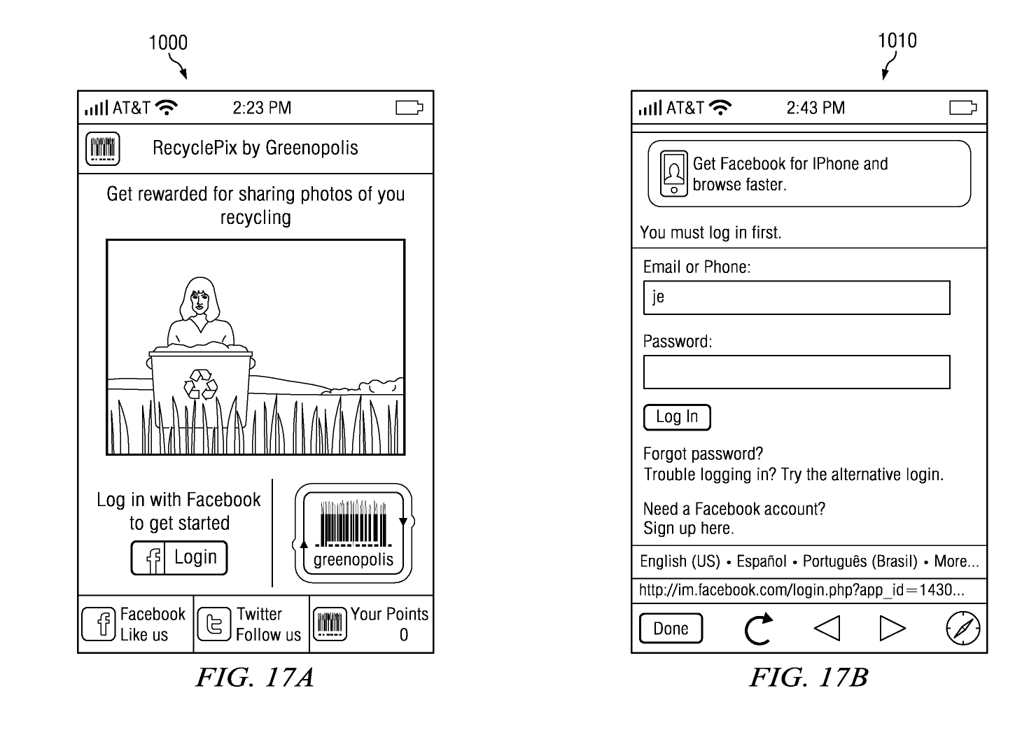

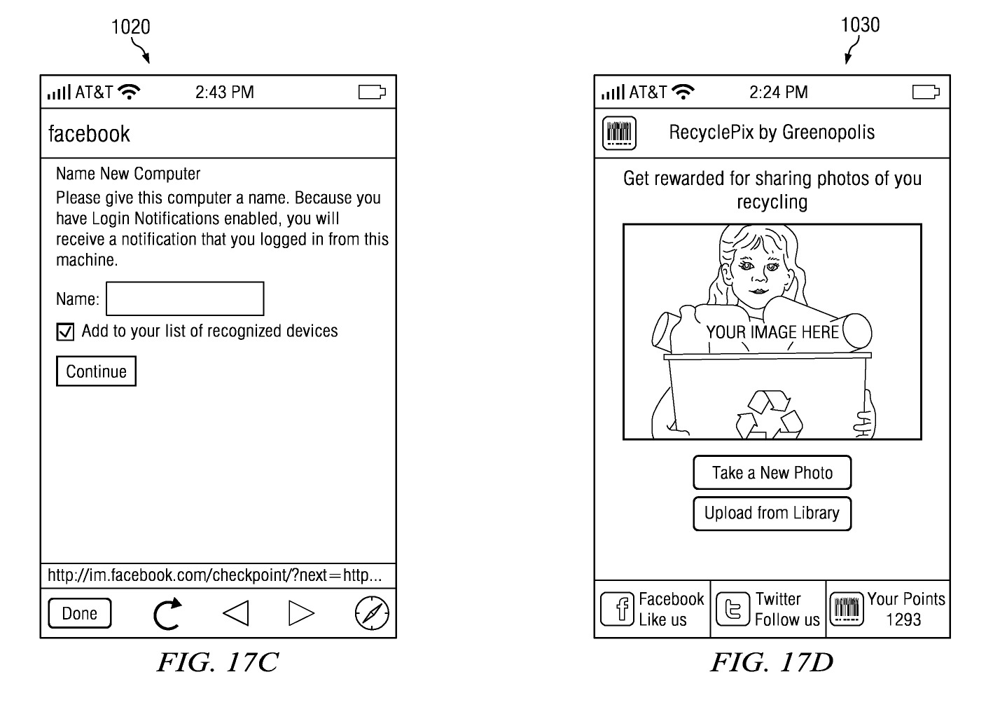

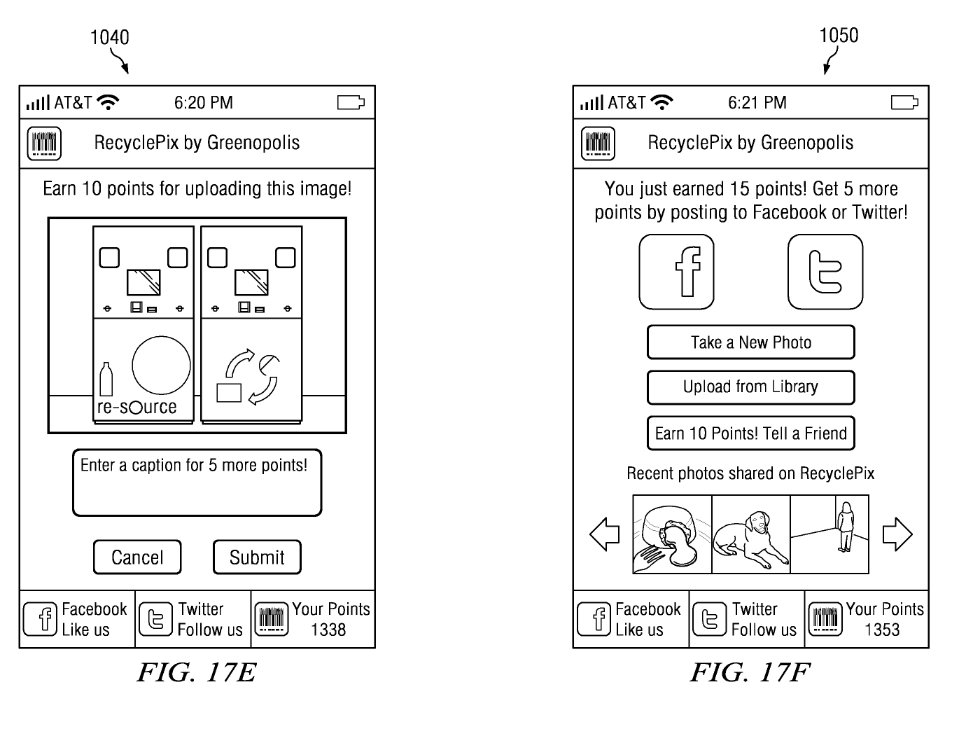

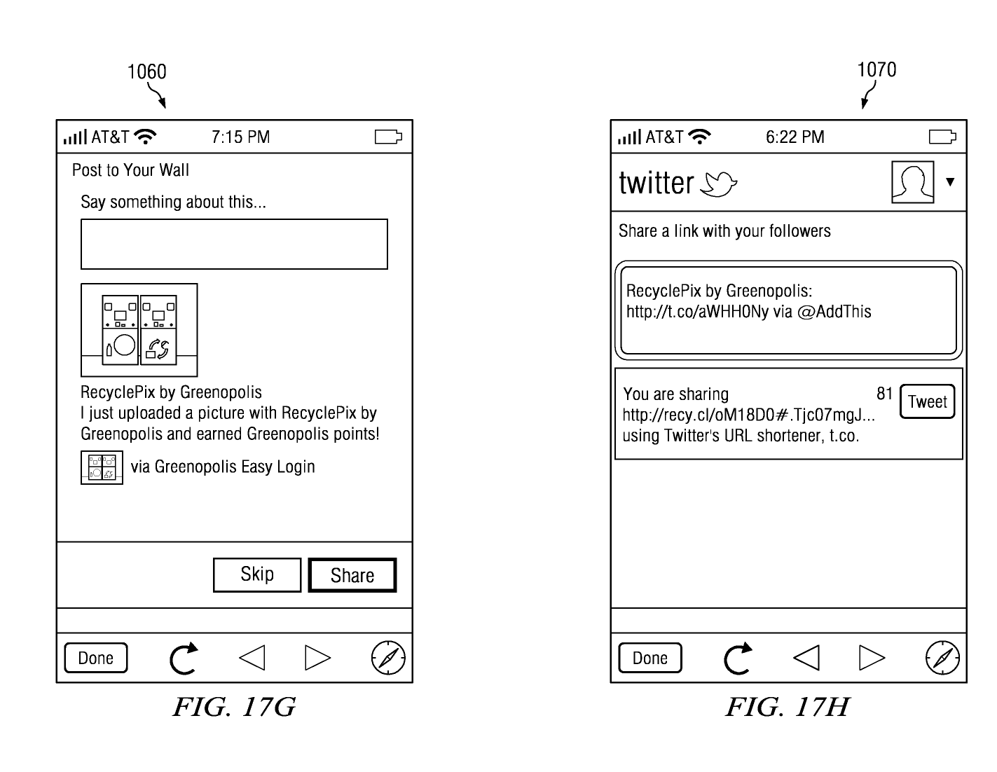

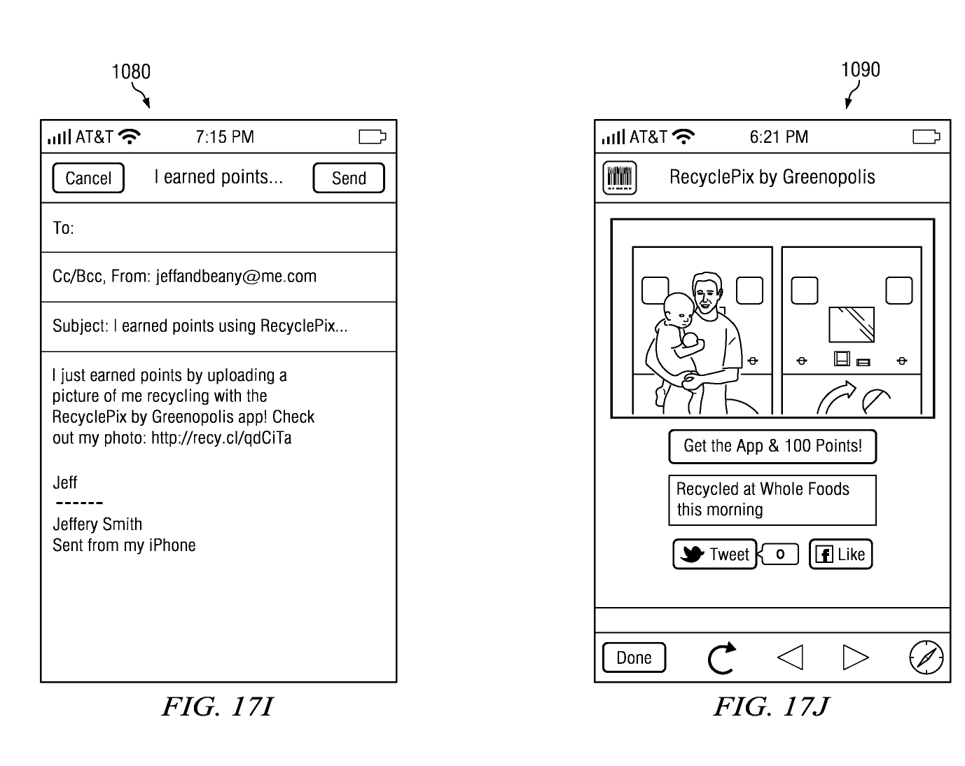

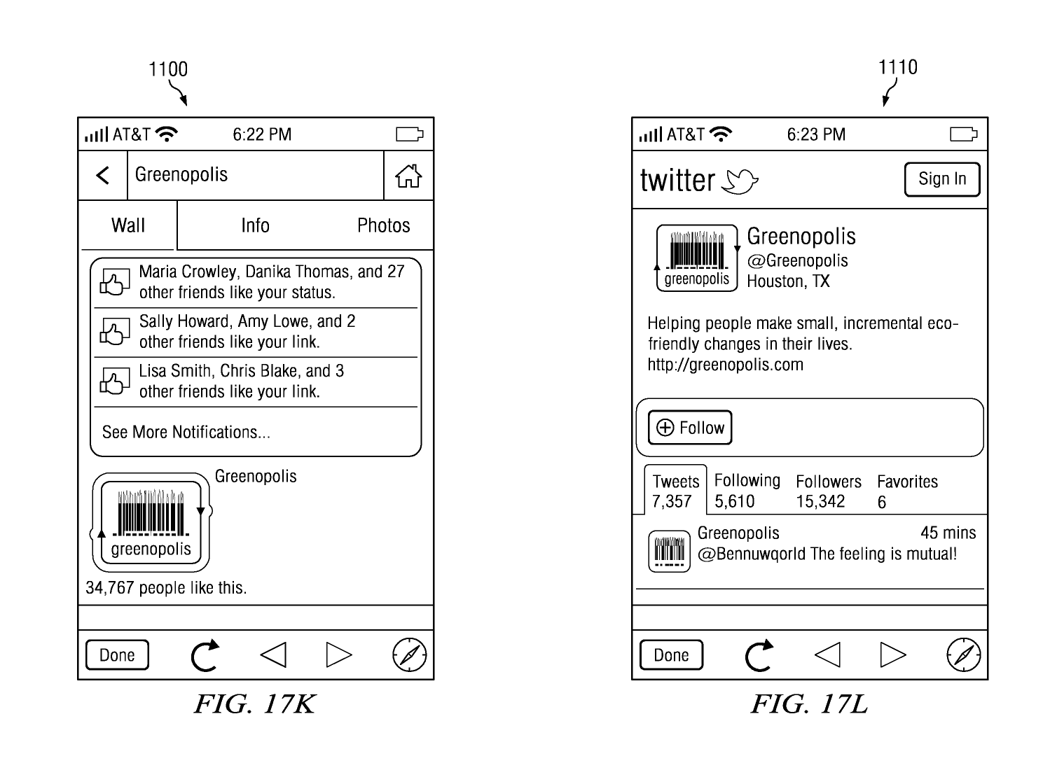

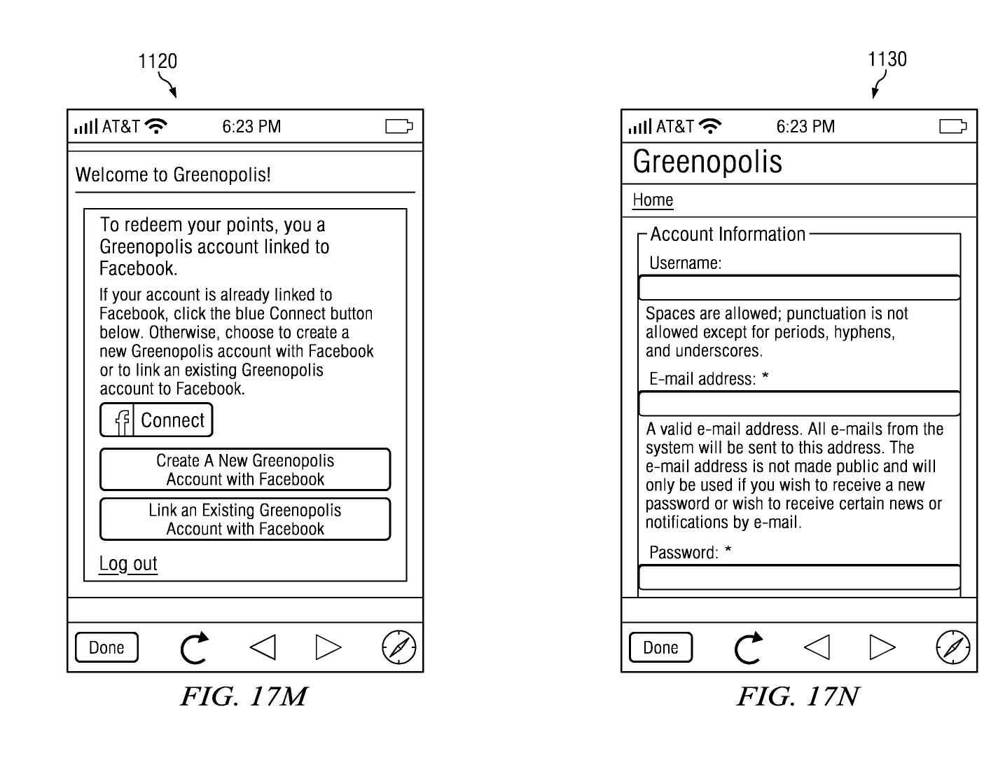

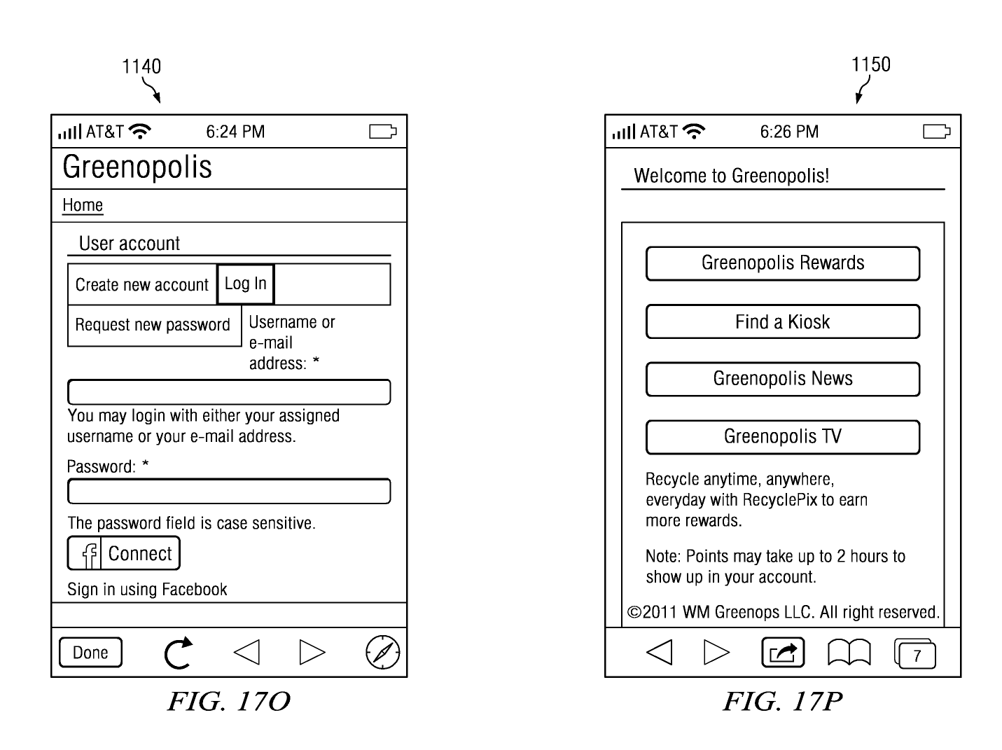

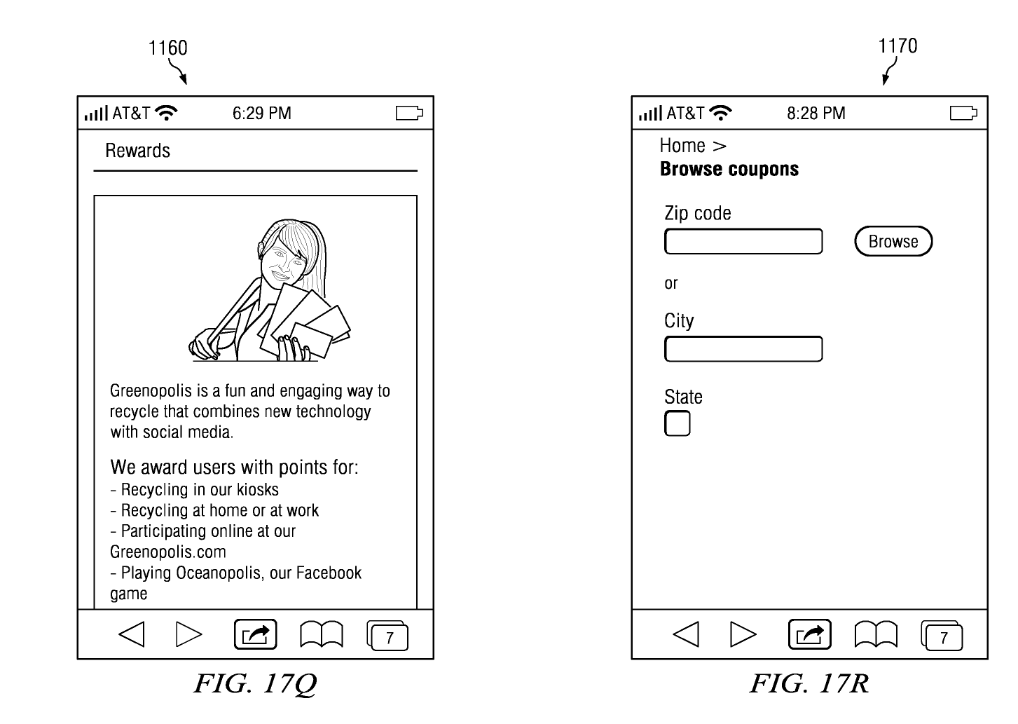

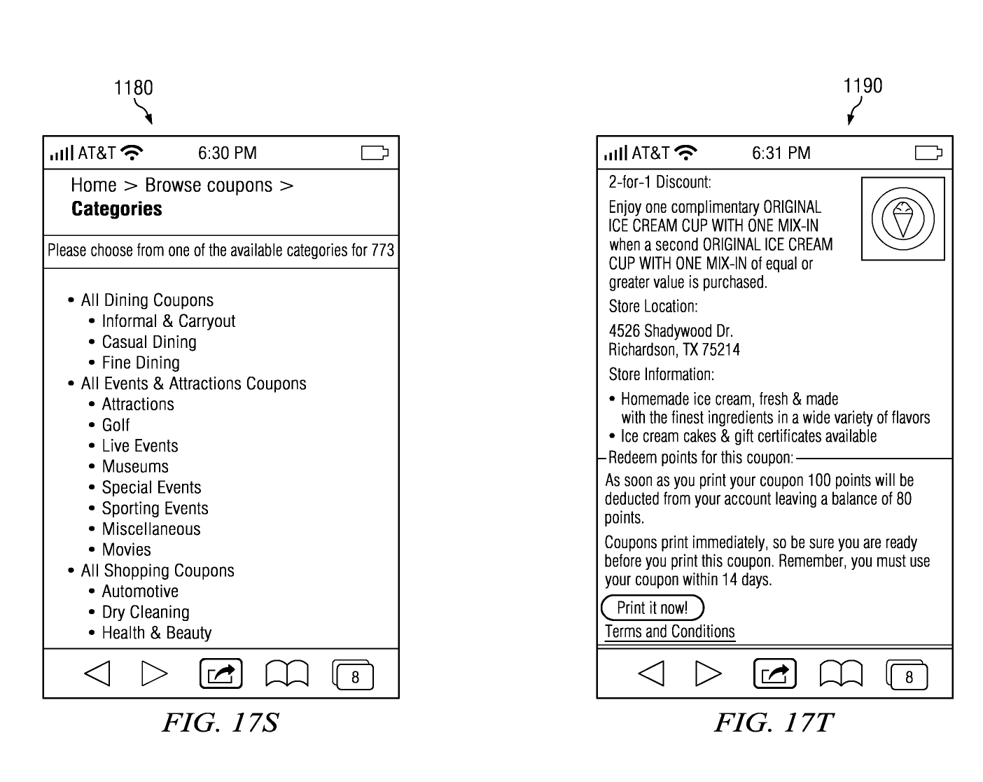

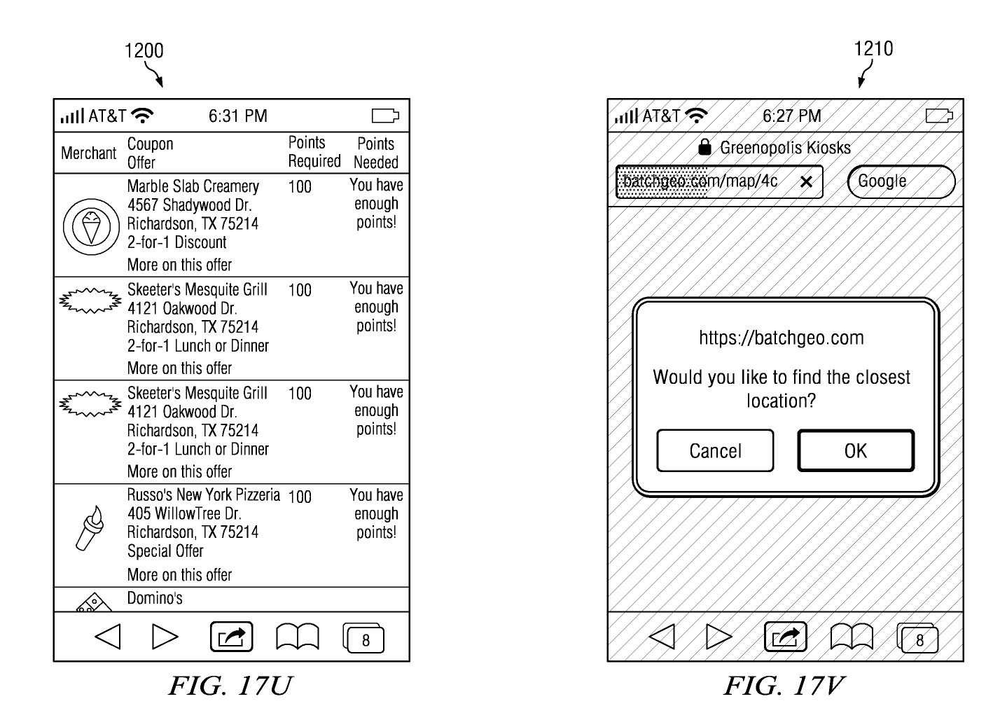

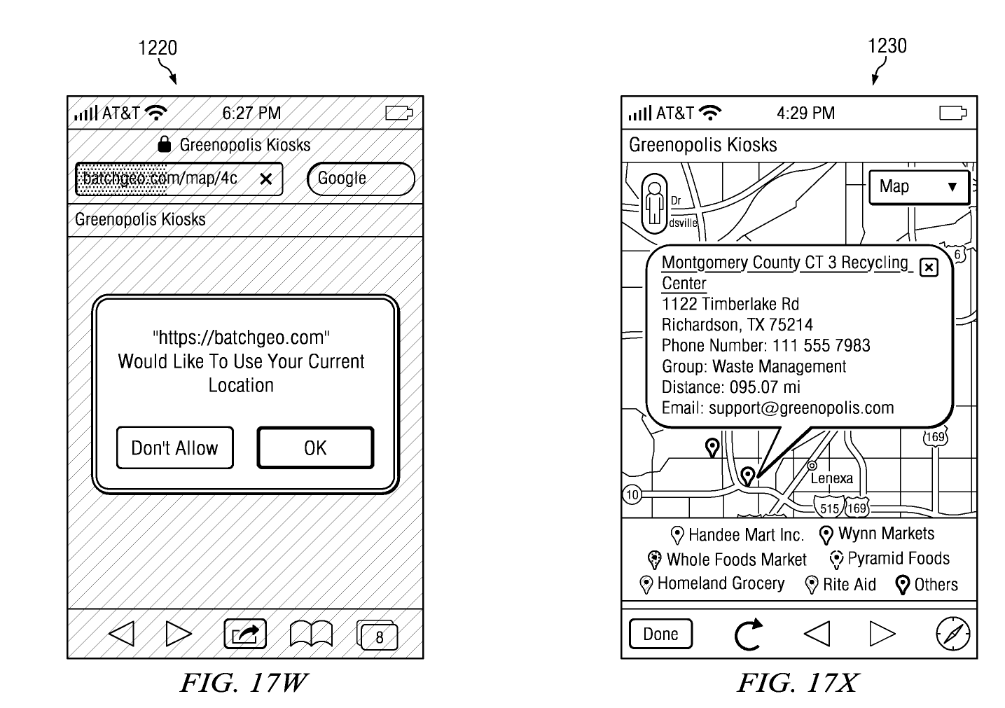

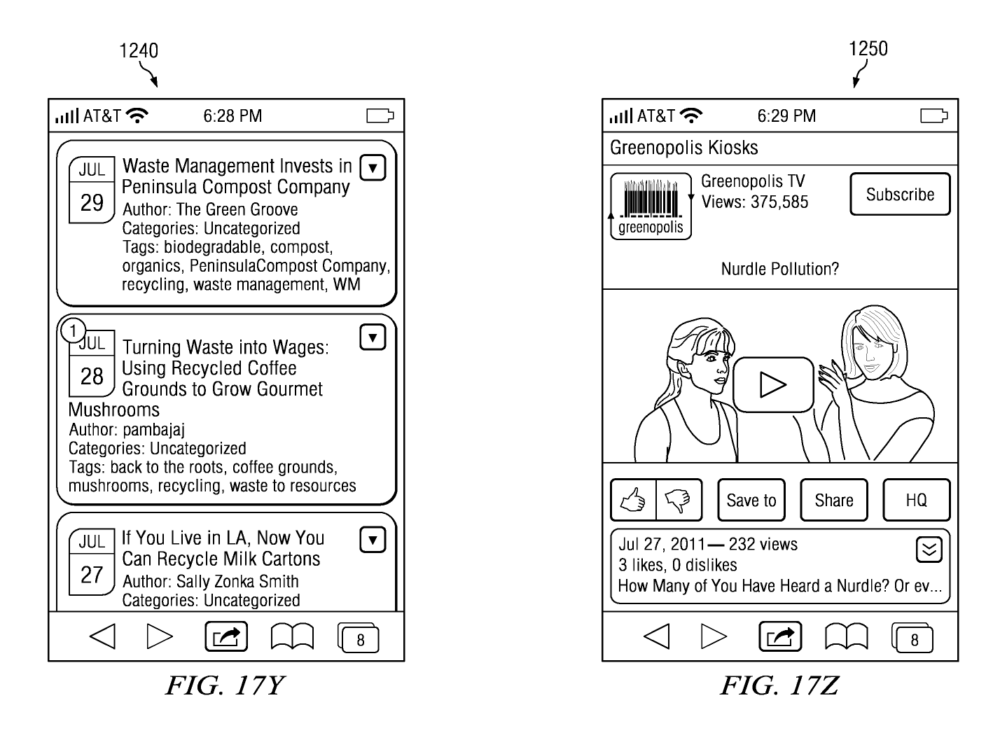

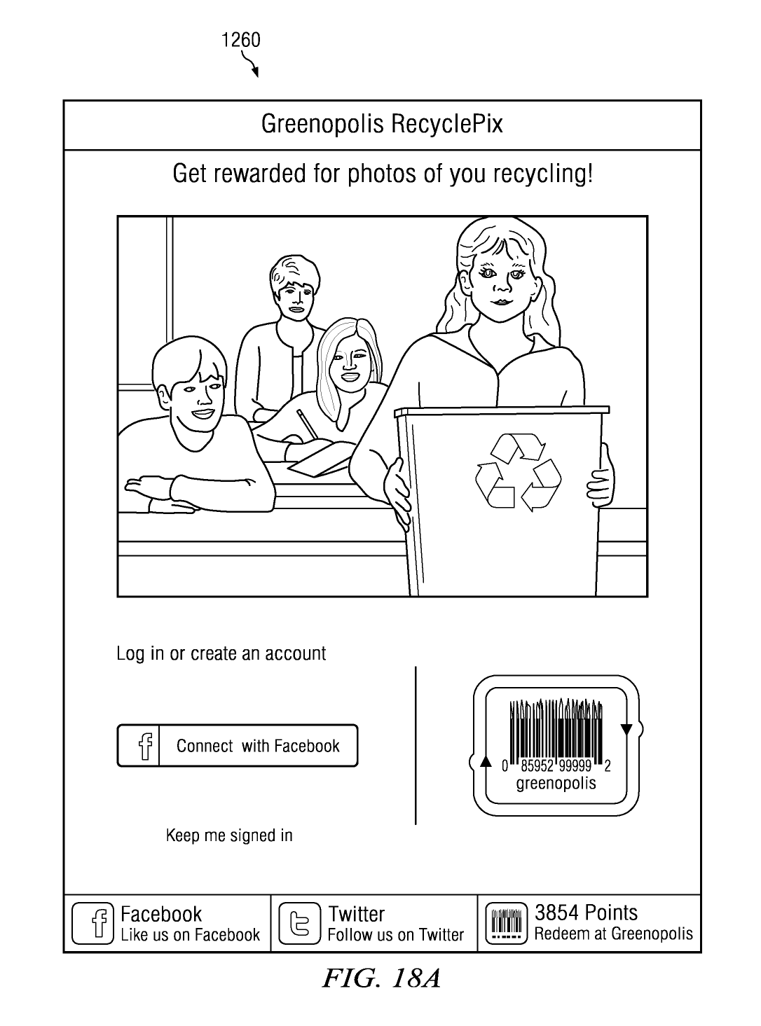

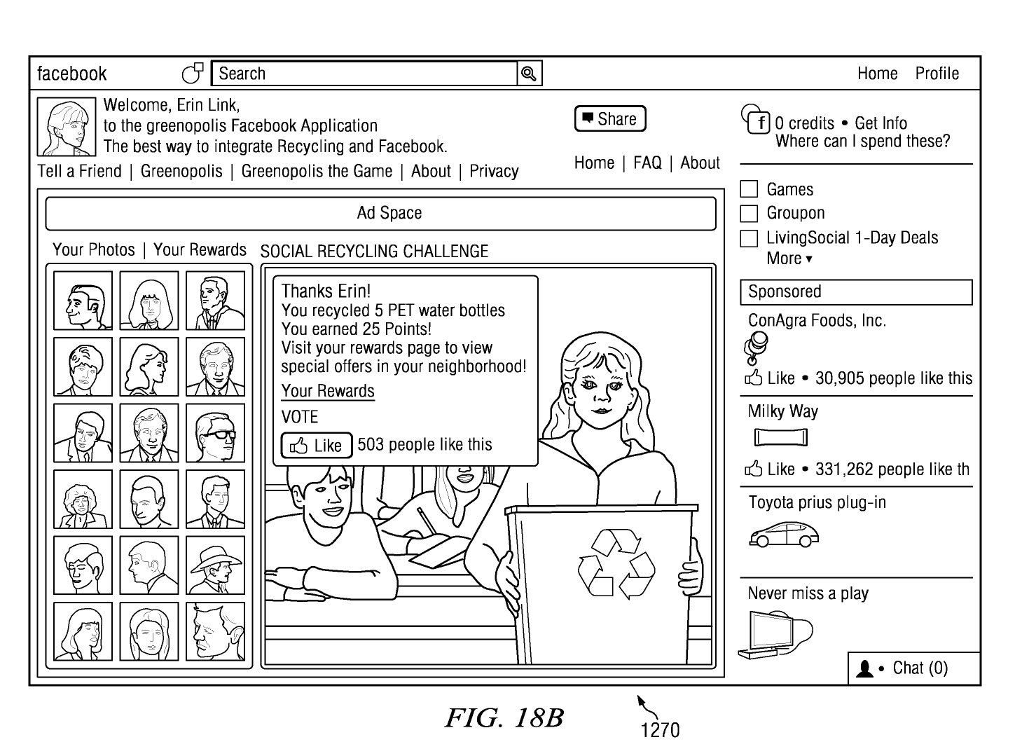

Non-limiting flow charts illustrating a method for photosharing recycling related photographs in accordance with an embodiment of the present invention, are shown in FIGS. 16B-16C. As shown at block 912, upon execution, the recycling user logs in to a social networking site using without limitation the photosharing App. Users of the photosharing App are identified by their accounts on the social networking site, such as without limitation Facebook or Twitter. The first time the App is started, the user is presented with a pop-up dialog to log in to the social networking site. The recycling user is prompted to provide an existing username and password or to register for a new account. For instance, the graphical user interface shown in FIG. 17B may be displayed to enter the username and password. According to one possible implementation, the URL the user is sent to is constructed using the below variables:

var authorize_url = “https://graph.facebook.com/oauth/authorize?”;

authorize_url += “client_id=“ + client_id;
authorize_url += “&redirect_uri=“ + redirect_uri;
authorize_url += “&display=“+ ( display ? display : “touch” );
authorize_url += “&type=user_agent”;
authorize_url += “&scope=publish_stream,offline_access”;

Optionally, a web browser window is created to obscure the photosharing App while the social networking site login is in progress.

As shown at block 914, if the user has never authorized this application to access their social networking site account, they are prompted to grant that permission. For instance, the graphical user interface shown in FIG. 17C may be displayed to add the user's computer or portable device to a list of recognized devices.

According to one possible implementation, upon successful login, the social networking site redirects the web browser to the redirect_uri referenced above, as shown at block 918. The URL contains an HTTP variable named “code.” The code below is substituted into the following standard social networking site API URL:

https://graph.facebook.com/oauth/access_token?

client_id=YOUR_APP_ID&redirect_uri=YOUR_URL&
client_secret=YOUR_APP_SECRET&code=THE_CODE_FROM_ABOVE

A long unique string ‘access_token’ is returned from the social networking site. The photosharing App closes the pop-up browser window. The resultant security token and some of the available user data may be stored locally on the user's computer, portable device or the like such that the next time the App is started the security token may be used and the login phase may be skipped. The above is stored using LocalStorage facility of HTML5:

LocalStorage.set|tem(‘access_token’, ‘abcdefghij . . . ’);

The token is thereafter retrievable from LocalStorage. The data is stored on the user's computer, portable device or the like in non-volatile storage such that it is saved between application runs or device restarts:

var myToken=LocalStorage.get|tem(‘access_token’);

As shown at block 952, the photosharing App connects to a photosharing server, such as without limitation the GreenOps server, via a network, such as the Internet or Intranet. At least some portion of the data received from the social network site is sent from the photosharing App to the photosharing server and/or Greenopolis server, as shown at block 954. As shown at block 956, the photosharing App then receives a current tally of that user's reward points, individual messages to display to the user via pop-up dialog message, and other metadata, from the photosharing server and/or Greenopolis server.

$.post(webURL

{ action:’connectuser’,fbuid: localStorage.getItem(‘facebook_id’) },

function(data,textStatus,jqXHR) {

handleServerData(data)

}

);

According to one embodiment, the photosharing server is independent of the Greenopolis server. According to this embodiment, the photosharing server in turn connects to the Greenopolis server responsible for tracking the user's reward points for all GreenOps services, as shown at block 958. The connection method is HTTP, the data is passed via URL, and the structure for the URL is:

$url = $urlbase . strval($userId) . ‘/’ . strval($amount) . ‘/’ . $hash .

‘?timestamp=‘ . time( );

Alternatively, according to another embodiment, the photosharing server is part of the Greenopolis server and the above connection may or may not occur.

As shown at block 960, to detect and prevent fraudulent or repeated transactions, an optional MD5 hash may be constructed containing the userId, timestamp and point amount.

The user's status, balance and other information are returned from the Greenopolis server to the photosharing server, and then relayed directly or indirectly to the photosharing App, as shown at block 962:

$response[‘status’] = (string)$greenopolis_xml[0]−>status;
$response[‘balance’] = (int)$greenopolis_xml[0]−>balance;
$response[‘description’] = (string)$greenopolis_xml[0]−>description;

The on-screen points display is updated to reflect server supplied totals, any personalized messages are displayed, and other metadata is cached locally on the user's device for later use. The mechanism for updating all displays of the current point total:

var divs = document.getElementsByName(‘points’);
for (i = 0; i < divs.length; i++) { divs[i].innerHTML = num; }

If a server supplied message was included in the response, the user is notified:

if((parsed[‘user_message’] != undefined) && (parsed[‘user_message’].length> 0)) {

navigator.notification.alert(parsed[‘user_message’],

alertMessageDismissed,’RecyclePix by Greenopolis’,’OK!’);

}

As shown at block 920, a recycling related photograph is received and uploaded. The recycling related photograph may be received from a camera or uploaded from an existing photo library. The user may use a camera on the user's computer, portable device or the like to take one or more photographs of recycling activities. The user chooses to upload either a newly captured photograph or a photograph previously captured that was stored in the device's photo album. Optionally, geographic location, photo caption, and other data is collected from the user and device, then the complete set of data is uploaded via Internet to the GreenOps server.

$.post( webURL,

{

action:’upload_photo’,
fbuid: window.localStorage.getItem(‘facebook_id’),
thisImage: currentImageData,
caption: document.getElementById(‘caption’).value

}

);

For instance, the graphical user interface shown in FIG. 17F may be used to take a photograph or upload a photograph from an existing library. The photograph and related information is then uploaded to the photosharing server and/or Greenopolis server.

The image may be resized to various predetermined useful sizes and saved to permanent storage on, or in communication with, the photosharing server and/or Greenopolis server. According to one embodiment, the uploaded data and image is stored in a SQL relational database for future processing, retrieval and publishing.

The photosharing server and/or Greenopolis server sends the new points total for the user, customized messages, and metadata pertaining to the image just uploaded to the computer, mobile device or the like, as shown at block 922. The metadata may be used to prefill and/or automatically submit messages to various social networking sites to spread awareness of the newly uploaded photograph. The metadata may also be used to allow users to send email to other Internet users containing a tailored message and links to the newly uploaded photograph.

document.getElementById(‘congratsmsg’).innerHTML =

“<p style=‘margin-top:−10px’>“+cmsg+”</p>“;

localStorage.setItem(‘fb_post_message’,
serverData[‘fb_post_message’]);
localStorage.setItem(‘fb_action_link_href’,
serverData[‘fb_action_link_href’]);
localStorage.setItem(‘fb_action_link_text’,
serverData[‘fb_action_link_text’]);
localStorage.setItem(‘tw_message’, serverData[‘tw_message’]);
localStorage.setItem(‘photo_url’, serverData[‘photo_url’]);
localStorage.setItem(‘email_subject’, serverData[‘email_subject’]);
localStorage.setItem(‘email_body’, serverData[‘email_body’]);
localStorage.setItem(‘photo_link’, serverData[‘photo_link’]);

As shown at block 924, a thumbnail of the photograph along with link to the full size version of the photograph on the photosharing server and/or Greenopolis server are added to the user's account on the social networking site. Users can click this small version of any photograph, spawning a pop-up web browser to view a larger version with its metadata such as caption. According to one possible implementation, a Facebook posting might include the following:

var dialogURL = “http://www.facebook.com/dialog/feed?app_id=“ +

appId + “&link=“ + encodeURIComponent(localStorage.photo_link) + “&picture=“ +
encodeURIComponent(localStorage.photo_url) + “&caption=“ +
encodeURIComponent(localStorage.fb_post_message) +
“&display=touch&redirect_uri=“ +
encodeURIComponent(‘http://oceanopolis.greenopolis.com/challenge/postsuccess.php’);

A Twitter posting might include the following:

window.plugins.childBrowser.showWebPage(“http://twitter.com/share?text=“ +

encodeURIComponent(localStorage.tw_message + localStorage.photo_link));

According to one embodiment, a scrolling album of photographs previously uploaded by both the user and other users of the app is displayed after each upload.

The user may also presented with buttons to post links to any of these photographs to social networking sites or email links in a manner similar to posting the user's own uploaded photograph.

As shown at block 926, third parties may be notified via the social networking site, server 906, email, instant message, text message, voice message, pop-up dialog or other communication. Third parties notified via social networking site or via email view uploaded picture can click the included link and view the photograph and related information stored on the photosharing server and/or Greenopolis server using a web browser. A large version of the appropriate photograph is displayed, as well as buttons so that these third party users may themselves also post messages and links to social networking sites.

According to one possible implementation, at least a portion of the database schema used with respect to the photosharing module is shown below:

app_loads table
\grave{ }id\grave{ } int(11)
\grave{ }fbuid\grave{ } bigint(20)
\grave{ }logged\grave{ } timestamp
photos table
\grave{ }id\grave{ } int(11)
\grave{ }fbuid\grave{ } bigint(20)
\grave{ }userid\grave{ } int(11)
\grave{ }item_category\grave{ } int(11)
\grave{ }item_special\grave{ } int(11)
\grave{ }howmany\grave{ } int(11)
\grave{ }image_name\grave{ } text
\grave{ }message\grave{ } text
\grave{ }created\grave{ } timestamp
\grave{ }score\grave{ } int(11)
\grave{ }moderated\grave{ } tinyint(1)
\grave{ }team\grave{ } int(11)
\grave{ }points_scored\grave{ } int(11)
\grave{ }points_to_team\grave{ } tinyint(1)
usage_log table
\grave{ }id\grave{ } int(11)
\grave{ }fbuid\grave{ } bigint(20)
\grave{ }action\grave{ } varchar(64)
\grave{ }data\grave{ } text
\grave{ }stamp\grave{ } timestamp
user table
\grave{ }fbuid\grave{ } bigint(20)
\grave{ }firstname\grave{ } text
\grave{ }lastname\grave{ } text
\grave{ }points\grave{ } int(11)
\grave{ }created\grave{ } timestamp
\grave{ }thirdpartyid\grave{ } varchar(64)
\grave{ }team\grave{ } int(11)
\grave{ }id\grave{ } int(11)
\grave{ }points_for_transfer\grave{ } int(11)

The present invention thus includes a computer program which may be hosted on a storage medium and includes instructions which perform the processes set forth in the present specification. The storage medium can include, but is not limited to, any type of disk including floppy disks, optical disks, CD-ROMs, magneto-optical disks, ROMs, RAMs, EPROMs, EEPROMs, flash memory, magnetic or optical cards, or any type of media suitable for storing electronic instructions.

Obviously, many other modifications and variations of the present invention are possible in light of the above teachings. The specific embodiments discussed herein are merely illustrative, and are not meant to limit the scope of the present invention in any manner. It is therefore to be understood that within the scope of the disclosed concept, the invention may be practiced otherwise then as specifically described.

1. A computer program product embodied on a computer readable medium for sharing recycling related photographs with third parties on a social network site to encourage recycling, the computer program product comprising:
a first computer code for receiving a recycling related photograph from a recycling user, wherein the recycling user has a first user account on a recycling related web server, and wherein the recycling related web server is in communication with a database having a reward point total and recycling data associated with the recycling user;
a second computer code for receiving information related to the recycling related photograph, wherein the information comprises a description of the recycling related photograph;
a third computer code for transmitting the recycling related photograph and at least a portion of the information to the recycling related web server via a network;
a fourth computer code for creating a user selectable link to the recycling related photograph on the first user account via the network, wherein the user selectable link comprises at least a portion of information;
a fifth computer code for authorizing the recycling user access to a second user account on a social networking site via the network;
a sixth computer code for transmitting the user selectable link to the second user account on the social networking site via the network, wherein the user selectable link is accessible to third parties on the social networking site and wherein the recycling related photograph on the recycling related web server is displayed to the third parties upon selection of the user selectable link; and
a seventh computer code for adding a predefined reward amount to the reward point total in exchange for the recycling user sharing the recycling related photographs with third parties on the social network site.

2. The computer program product of claim 1, wherein the user selectable link further comprises a thumbnail of the recycling related photograph.

3. The computer program product of claim 1, wherein the information further comprises metadata.

4. The computer program product of claim 1, further comprising an eighth computer code for transmitting an electronic communication to one or more of the third parties over the network, wherein the electronic communication comprises at least one selected from the group consisting of an identification of the recycling related photograph, the user selectable link, and the recycling related photograph.

5. The computer program product of claim 4, wherein the electronic communication is communicated to the one or more third parties over the network via at least one selected from the group consisting of SMS, an email and a communication protocol.

6. The computer program product of claim 1, wherein the recycling related photograph and the information are received on a portable device.

7. The computer program of claim 6, the portable device comprises at least one selected from the group consisting a smart phone, a tablet computer, a handheld computer, a laptop computer, a mobile Internet device, and a personal digital assistant (PDA).

8. The computer program of claim 1, further comprising an eighth computer code for constructing a MD5 hash containing at least a portion of the information to detect and prevent fraudulent or repeated transactions.

9. A system for sharing recycling related photographs with third parties on a social network site to encourage recycling, the system comprising:
a central server;
a plurality of remote computers of recycling users having a first user account on the central server;
a network interface in communication with the central server, the plurality of remote computers over a network, and one or more social networking sites;
a database in communication with the central server, wherein the database comprises a reward point total and recycling data respectively associated with the recycling users;
wherein at least one of the plurality of remote computers is configured to:
receive a recycling related photograph from at least one of the recycling users;
receive information related to the recycling related photograph, wherein the information comprises a description of the recycling related photograph;
transmit the recycling related photograph and at least a portion of the information to the central server;
create a user selectable link to the recycling related photograph on the first user account via the network, wherein the user selectable link comprises at least a portion of information;
authorize the recycling user access to a second user account on the social networking site via the network; and
transmit the user selectable link to the second user account on the social networking site via the network, wherein the user selectable link is accessible to third parties on the social networking site, and wherein the recycling related photograph on the recycling related central server is displayed to the third parties upon selection of the user selectable link; and
wherein the central server is configured to:
receive the recycling related photograph and at least a portion of the information from the at least one of the plurality of remote computers via the network interface;
store the recycling related photograph and the at least a portion of the information in the database, wherein the recycling related photograph is accessible on the central server to third parties via the user selectable link;
transmit the reward point total and recycling data associated with the respective recycling user to the at least one of the plurality of remote computers via, the network interface; and
add a predefined reward amount to the reward point total in exchange for the recycling user sharing the recycling related photographs with third parties on the social network site.

10. The system of claim 9, wherein the user selectable link further comprises a thumbnail of the recycling related photograph.

11. The system of claim 9, wherein the information further comprises metadata.

12. The system of claim 9, wherein an electronic communication is communicated to one or more third parties over the network via at least one selected from the group consisting of SMS, an email and a communication protocol.

13. The system of claim 12, wherein the at least one of the plurality of remote computers is further configured to transmit the electronic communication to the one or more of the third parties, wherein the electronic communication comprises at least one selected from the group consisting of an identification of the recycling related photograph, the user selectable link, and the recycling related photograph k.

14. The system of claim 12, wherein the central server is further configured to transmit the electronic communication to the one or more of the third parties, wherein the electronic communication comprises at least one selected from the group consisting of an identification of the recycling related photograph, the user selectable link, and the recycling related photograph.

15. The system of claim 12, wherein the social networking site transmits the electronic communication to the one or more of the third parties, wherein the electronic communication comprises at least one selected from the group consisting of an identification of the recycling related photograph, the user selectable link, and the recycling related photograph.

16. The system of claim 9, wherein the recycling related photograph and the information are received on a portable device.

17. The system of claim 9, the portable device comprises at least one selected from the group consisting a smart phone, a tablet computer, a handheld computer, a laptop computer, a mobile Internet device, and a personal digital assistant (PDA).

18. The system of claim 9, wherein the central server is further configured to construct a MD5 hash containing at least a portion of the information to detect and prevent fraudulent or repeated transactions.

19. The system of claim 9, wherein at least one of the plurality of remote computers is configured to construct a MD5 hash containing at least a portion of the information to detect and prevent fraudulent or repeated transactions.
